(19) United States
(12) Patent Application Publication
(10) Pub. No.: US 2009/0178110 A1
(43) Pub. Date: Jul. 9, 2009

(54) Communication Control Device, Communication Control System, Communication Control Method, and Communication Control Program

(75) Inventor: Naoshi Higuchi, Tokyo (JP)

Correspondence Address: NEC CORPORATION OF AMERICA, 6535 N. STATE HWY 161, IRVING, TX, 75039, US

(73) Assignee: NEC CORPORATION, Tokyo (JP)

(21) Appl. No.: 12/281,507

(22) PCT Filed: Mar. 1, 2007
(86) PCT No.: PCT/JP2007/053921

§ 371 Date: Sep. 3, 2008

(30) Foreign Application Priority Data
Mar. 3, 2006 (JP) 2006-058593

(51) Int. Cl. G06F 21/00

(52) U.S. Cl. 726/1; 726/14

(57) ABSTRACT

The communication control device of the present invention includes: a communication parameter acquisition means (105) for acquiring communication parameters that specify the transmission origin of an outside apparatus based on existence information of the outside apparatus that is received from a communication network, an apparatus identifier acquisition means (104) for acquiring from the outside apparatus an apparatus identifier that is an identifier for the outside apparatus, a policy determination means (106) for determining a communication policy for permitting or prohibiting communication with the outside apparatus that is specified by the apparatus identifier, a communication selection rule combining means (107) for combining communication selection rules based on the communication policy and communication parameters, and a communication pass control means (108) for passing or blocking communication with the outside apparatus based on the communication selection rules that have been combined by the communication selection rule combining means.

### TECHNICAL FIELD

The present invention relates to a communication control device, a communication control system, a communication control method, and a communication control program for controlling the permission of communication between a terminal device and an outside apparatus by way of a communication network.

### BACKGROUND ART

Recent years have seen the widespread adoption of a technology of a communication control system by which a terminal device, as a communication device such as a personal computer provided with communication functions, automatically discovers and uses an outside apparatus similarly provided with communication functions by way of a communication network. A variety of types of devices may serve as the outside apparatus, including printers, media servers, camera devices for fixed-point observation, and Internet gateway devices.

The technology of the above-described communication control system includes UPnP (Universal Plug and Play), Rendezvous, Salutation, and Jini (Java Intelligent Network Infrastructure). In all instances of this technology, a terminal device on the side that uses an outside apparatus and the outside apparatus are connected to a communication network, the terminal device and the outside apparatus mutually discover a partner by way of this communication network and mutually control the partner by way of the communication network. In addition, the terminal device on the side that uses the outside apparatus need not be a personal computer as long as it is a device provided with communication functions according to technical standards. Still further, the outside apparatus is not only a monofunctional device referred to as an “appliance” in technical standards but may also be a device in which an ordinary device such as a personal computer is provided with communication functions.

In a communication control system that employs technology such as the above-described UPnP, Rendezvous, Salutation, and Jini, a terminal device and an outside apparatus mutually discover a partner by way of a communication network and mutually control the partner by way of the communication network, and the terminal device and outside apparatus can therefore both become the object of “cracking” (attacks) in which data are damaged by way of the communication network.

In addition, in recent years, a technology is coming into wide use in personal computers provided with communication functions for classifying communication that its own terminal sends and receives and blocking communication that diverges from classifications to protect its own terminal from attacks that come by way of communication. This protection technology is referred to as a personal firewall.

The previously described technology for using an outside apparatus by way of communication must not be excluded from selection in the above-described protection technology, because once excluded from selection, control of an outside apparatus by way of mutual automatic discovery and control by way of communication no longer operates.

In addition, a personal firewall must not pass communication other than that for the automatic discovery of an outside apparatus and the control of an outside apparatus. Allowing other communication to pass opens the possibility of an attack by way of communication.

Although the address of a communication partner, of which an IP address is representative, has been used as a setting parameter of this personal firewall, in recent years, addresses are often automatically assigned upon startup of the power supply of an outside apparatus in a communication control system as represented by DHCP (Dynamic Host Configuration Protocol) and it is therefore impossible to ascertain an address beforehand and set the personal firewall.

In addition, the address of the outside apparatus frequently changes when the power supply of an outside apparatus is cut off and then re-started, and the settings of the personal firewall must therefore follow. An example of a communication control system of the related art is disclosed in JP-A-2005-18769.

In this technique of the related art, a method is disclosed for altering the settings of a firewall in accordance with a request from an application. In this related art, the parameters of a partner with whom an application wishes to communicate are delivered to a firewall, and when the firewall compares a policy for determining whether communication is to be allowed or not with the above-described parameters that have been delivered and permits communication, the settings of the firewall are changed.

### DISCLOSURE OF THE INVENTION

The above-described communication control technology has the several drawbacks, as described below.

The first drawback is the difficulty (impossibility) of performing appropriate settings in the firewall for controlling an outside apparatus in the method of transferring to the firewall the parameters of a partner with whom the application of the related art wishes to communicate. This difficulty arises because, in the method of the related art, the parameters of the partner with whom the application wishes to communicate, i.e., the outside apparatus, must be known beforehand, but there is no way for the application to ascertain the parameters of the outside apparatus.

The second drawback in the method of transferring to the firewall the parameters of the partner with whom the application of the related art wishes to communicate is the difficulty (impossibility) of following firewall settings without changing the policy for permitting or prohibiting communication for each outside apparatus when the parameters of the outside apparatus have changed. This difficulty arises because the parameters of the outside apparatus may change when, for example, the power supply of the outside apparatus is started up, but there is no way for the application to ascertain the parameters of the outside apparatus after the change, and moreover, because the outside apparatus is not stored in association with the policy.

It is an object of the present invention to provide a communication control device, a communication control system, a communication control method, and a communication control program that allow setting of appropriate communication selection rules for a firewall that is provided in apparatuses in each of the apparatuses that make up an apparatus-linking system.

The communication control device according to the present invention is a communication control device for, when communication is carried out with an outside apparatus by way of a communication network, determining and controlling whether communication with the outside apparatus is to be permitted or not, the communication control device being of a configuration that includes: a communication parameter acquisition means for acquiring communication parameters for specifying the transmission origin of an outside apparatus based on existence information of the outside apparatus that is received from the communication network; an apparatus identifier acquisition means for acquiring an apparatus identifier from an outside apparatus, the apparatus identifier being an identifier for the outside apparatus; a policy determination means for determining a communication policy for permitting or prohibiting communication with the outside apparatus specified by the apparatus identifier; a communication selection rule combining means for combining communication selection rules based on the communication policy and communication parameters; and a communication pass control means (firewall means) for passing or blocking communication with the outside apparatus based on the communication selection rules that have been combined by the communication selection rule combining means.

According to the present invention, a communication policy is determined based on an apparatus identifier that accords with an outside apparatus that is a communication partner, and further, communication selection rules are combined by means of this communication policy and communication parameters, and the permission or prohibition of communication with the outside apparatus is determined based on these combined communication selection rules. The communication selection rules are combined based on an apparatus identifier that is unique to the outside apparatus, and as a result, even if the communication parameters of the outside apparatus change, settings for the passage or blockage of communication with the outside apparatus can be continued and carried out appropriately without being misled by any change.

Here, the above-described communication control device may further include: a communication selection rule storage means for storing and placing in correspondence communication selection rules and apparatus identifiers with the apparatus identifiers as keys and the communication selection rules that have been combined as values; an old communication selection rule deleting means for releasing, from the communication pass control means, settings of communication selection rules that have been extracted from the communication selection rule storage means with apparatus identifier as key; and communication selection rule setting means for both causing storage of sets of apparatus identifiers and communication selection rules in the communication selection rule storage means and making settings in the communication pass control means.

In addition, in the above-described policy determination means, the first communication policy may be determined based on specific designated information that is received from the user of an outside apparatus by way of that outside apparatus, and further, the same content as the first policy may be determined for second and succeeding communication policies.

When reconnecting with the above-described outside apparatus, a communication selection rule updating means may be provided for both updating the communication selection rules that are stored in the communication selection rule storage means to communication selection rules that are newly determined and setting the updated communication selection rules in the communication pass control means; and this communication selection rule updating means may be provided together with the communication selection rule setting means.

In addition, for the purpose of solving the above-described drawbacks, the communication control device according to the present invention is a communication control device for, when communication is carried out with an outside apparatus by way of a communication network, controlling whether communication with the outside apparatus is to be permitted or not, the communication control device being of a configuration that includes: a policy storage means for storing policies indicating permission or blockage of communication with the outside apparatus for each apparatus identifier that uniquely identifies an outside apparatus; an apparatus discovery means for detecting an outside apparatus based on existence information that is received from the communication network and that indicates the existence of an outside apparatus; a communication parameter acquisition means for acquiring from the existence information communication parameters that specify the transmission origin of an outside apparatus that has been discovered by the apparatus discovery means; an apparatus identifier acquisition means for acquiring from the existence information an apparatus identifier that has been discovered by the apparatus discovery means; a policy determination means for both reading from the policy storage means a policy for an apparatus identifier that has been acquired by the apparatus identifier acquisition means and determining the policy that has been read as the policy of the outside apparatus; a communication selection rule combining means for, based on the policy that has been determined by the policy determination means, the apparatus identifier acquired by the apparatus identifier acquisition means, and the communication parameters acquired by the communication parameter acquisition means, combining communication selection rules that indicate whether to pass or block communication for the outside apparatus to which the apparatus identifier is assigned; and a communication pass control means for passing or blocking communication with an outside apparatus based on the communication selection rules that have been combined.

According to the present invention, communication selection rules characteristic of an outside apparatus are combined by the communication selection rule combining means based on a policy that has been determined by the policy determination means, an apparatus identifier that has been acquired by the apparatus identifier acquisition means, and communication parameters that have been acquired by the communication parameter acquisition means, and as a result, even in the event of alteration of the communication parameters of the outside apparatus, settings for the passage or blockage of communication with this outside apparatus can be effected appropriately without being misled by the changes in parameters.

Here, a policy inquiry means may be provided for functioning when the policy determination means is unable to determine the policy of the above-described apparatus identifier because a policy for the apparatus identifier was not stored in the policy storage means and for submitting an inquiry for the policy of the outside apparatus to which the apparatus identifier has been assigned, whereby the above-described policy determination means both determines that the policy for which the policy inquiry means has inquired is to be the policy of the outside apparatus and causes the determined policy to be stored in the policy storage means.

Thus, when a policy for an apparatus identifier has not been stored in the policy storage means, this configuration allows a policy inquiry means to submit an inquiry for the policy of this apparatus identifier to enable determination of the policy for an outside apparatus that has received for the first time.

In addition, a communication selection rule storage means for storing communication selection rules that have been combined by the above-described communication selection rule combining means together with the corresponding apparatus identifier and a communication selection rule storage determination means for determining whether communication selection rules having the same apparatus identifier as new communication selection rules that have been combined by the communication selection rule combining means are already stored or not in the communication selection rule storage means may be further included, whereby, upon determining that communication selection rules of an apparatus identifier that is the same as newly combined communication selection rules are already stored in the communication selection rule storage means, this communication selection rule storage determination means may update the communication selection rules that are stored to the communication selection rules that have been newly combined.

According to this configuration, the newest communication selection rules for an outside apparatus are always stored in the communication selection rule storage determination means, whereby, in the event of change of the communication parameters of an outside apparatus, the corresponding communication selection rules are immediately calculated and updated based on unchanging apparatus identifier information. As a result, the set control for passage or blockage of communication with an outside apparatus can be effected quickly and appropriately and with high reliability.

Still further, a configuration may be adopted in which an electronic signature is implemented in the above-described existence information, this configuration being provided with: a transmission origin authentication means for authenticating the transmission origin of an outside apparatus based on the signature that is implemented in existence information that is received from the outside apparatus; and a reliability determination means for determining whether the transmission origin of the outside apparatus that has been authenticated by this transmission origin authentication means can be trusted; and further, wherein the policy determination means is provided with a communication permitting/blocking determination capability for permitting communication of the policy of an outside apparatus when the reliability determination means has determined that the transmission origin of the outside apparatus can be trusted and for blocking communication of the policy of this outside apparatus when the reliability determination means has determined that the transmission origin of the outside apparatus cannot be trusted.

This configuration can further augment the reliability of a policy that has been combined by the policy determination means and can further raise the reliability of the operation of the communication pass control means that determines and executes passage or blocking of communication with an outside apparatus.

In addition, the communication control system according to the present invention is for, when carrying out communication between a terminal device and an outside apparatus by way of a communication network, determining and controlling whether to permit this communication; wherein the outside apparatus is provided with an existence information transmission means for transmitting existence information that indicates the existence of the outside apparatus itself to the terminal device; and the terminal device is both provided with the above-described communication control device as a communication control means, and is provided with a communication means (communication interface means) for carrying out communication by way of the communication network and a user interface means for receiving and supplying necessary information.

In this way, the operation control functions of the above-described communication control device can be effectively executed in the entire communication system, and during communication between a terminal device and an outside apparatus, the determination and execution of passing or blocking communication with an outside apparatus can be realized with the overall communication system always as the object of control, and on these points, the reliability of the operation of the communication pass control means can be raised.

Still further, the communication control method according to the present invention is a communication control method for, when carrying out communication with an outside apparatus by way of a communication network, determining and controlling whether to permit communication with the outside apparatus, the method including: an apparatus identifier/communication parameter acquisition step of acquiring, from the outside apparatus, an apparatus identifier that is the identifier for the outside apparatus and communication parameters that specify the transmission origin of the outside apparatus from existence information of the outside apparatus that is received from the communication network; a policy determination step of determining a communication policy for permitting or prohibiting communication with the outside apparatus that is specified by the apparatus identifier; a communication selection rule combining step of combining communication selection rules based on the communication policy and communication parameters; and a communication pass control step carried out in a communication pass control means that functions based on communication selection rules that have been combined and sets passage or blockage of communication with the outside apparatus.

According to the present invention, an apparatus identifier accorded to an outside apparatus that is the communication partner is acquired in real time, the communication policy is determined based on this apparatus identifier, and further, communication selection rules are combined by means of this communication policy and communication parameters. The determination of whether to enable communication with the outside apparatus is then realized based on these communication selection rules that have been combined, meaning that the communication selection rules are combined based on the apparatus identifier that is specific to that outside apparatus, and as a result, the setting of passage or blockage of communication with the outside apparatus can be continued appropriately without being influenced by the change or lack of change of the communication parameters of the outside apparatus. In addition, because the process of combining communication selection rules is always carried out first and the control process then executed based on the results, changes are naturally accepted even when the communication parameters change, and as a result, determination errors in the communication pass control step in the final step can be greatly suppressed and highly reliable results can be obtained.

The above-described communication control method may further include before the communication pass control step: a communication selection rule storage step of storing in the communication selection rule storage means the apparatus identifier and the communication selection rules in association with each other with the above-described apparatus identifier as a key and the combined communication selection rules as values; an old communication selection rule deletion step of releasing settings from the communication pass control means for communication selection rules acquired from the communication selection rule storage means with the apparatus identifier as key; and a communication selection rule setting step of both storing sets of the apparatus identifier and the communication selection rules in the communication selection rule storage means and setting in the communication pass control means.

In addition, a communication selection rule updating step may be further provided for, when communication selection rules have been newly combined due to reconnection with an outside apparatus and before the execution of the communication pass control step, updating the communication selection rules stored in the communication selection rule storage means to the communication selection rules that have been newly determined.

The communication control method according to the present invention is a communication control method for, when carrying out communication with an outside apparatus by way of a communication network, controlling whether or not to permit communication with the outside apparatus; the method including: an outside apparatus detection step of detecting an outside apparatus based on existence information that is received from the communication network and that indicates existence of the outside apparatus; an apparatus identifier/communication parameter acquisition step of acquiring from the existence information communication parameters that specify the transmission origin of the outside apparatus that has been detected and the corresponding apparatus identifier; a policy determination step of reading from a policy storage means, in which policies have been stored in advance for each apparatus identifier, a policy that indicates whether to permit or block communication with the outside apparatus to which the acquired apparatus identifier is assigned and determining this policy as the policy of the outside apparatus; a communication selection rule combining step of, based on the policy that has been determined and the apparatus identifier and communication parameters that have been acquired, combining communication selection rules that indicate whether to pass or block communication for the outside apparatus to which the apparatus identifier is assigned; and a communication pass control step of executing determination based on the communication selection rules that have been combined and passing or blocking communication with the outside apparatus.

In the communication selection rule combining step according to the present invention, communication selection rules specific to the outside apparatus are combined based on the policy that was determined in the policy determination step, the apparatus identifier that was acquired in the apparatus identifier acquisition step, and communication parameters that were acquired in the communication parameter acquisition step, and as a result, even in the event of change of the communication parameters of the outside apparatus, this change of parameters can be effectively assimilated and communication selection rules combined. As a result, settings for passing or blocking communication with the outside apparatus can be carried out appropriately in real time.

The method of the present invention may be further provided with: before the policy determination step, a policy inquiry step for, when the policy of an apparatus identifier that was acquired in the above-described apparatus identifier/communication parameter acquisition step was not stored in a policy storage means that was equipped in advance and the policy for the apparatus identifier therefore cannot be determined, inquiring to the outside for the policy of the outside apparatus to which the apparatus identifier is assigned; and a policy re-storing step for both determining this policy that was inquired for and obtained as the policy of the outside apparatus and again storing this policy in the policy storage means.

According to this configuration, when a policy for an apparatus identifier has not been stored in advance, an inquiry may be submitted for a policy for this apparatus identifier, whereby the policy for an outside apparatus that is received for the first time can be determined quickly.

In addition, the method of the present invention may be further provided with: before the communication pass control step, a communication selection rule storage determination step for determining whether communication selection rules having the same apparatus identifier as communication selection rules that have been combined in the previously described communication selection rule combining step are already stored in a communication selection rule storage means that has been provided in advance; and a communication selection rule updating step for, when it is determined that combined communication selection rules of an apparatus identifier are already stored, updating the stored communication selection rules to the newly combined communication selection rules.

According to this configuration, in the event of a change in communication parameters of the outside apparatus, corresponding communication selection rules are immediately calculated and updated based on unchanging apparatus identifier information. As a result, the control of settings for passing or blocking communication with the outside apparatus can be carried out appropriately and quickly with high reliability.

Still further, an electronic signature may be implemented in the above-described existence information; and the method may be further provided with: a transmission origin authentication step for authenticating the transmission origin of the outside apparatus based on a signature implemented in existence information that is received from the outside apparatus and a reliability determination step for determining whether the transmission origin of this outside apparatus that has been authenticated can be trusted or not; and a communication permission determination step may also be included for allowing communication of the policy of the outside apparatus when it is determined that the transmission origin of the outside apparatus can be trusted and blocking communication of the policy of the outside apparatus when it is determined that the transmission origin of the outside apparatus cannot be trusted.

The communication control program according to the present invention is configured to convert the content of each of the constituent elements of the above-described communication control device to a program and thus allows the above-described communication control method to be executed by a computer.

As a result, the communication control program executes the control content by means of a computer, has substantially equivalent action and effect as each of the above-described communication control devices that can realize the settings of passing or blocking communication with an outside apparatus (firewall settings), and further, is also endowed with the advantages of even greater versatility and speed of information processing that includes control operations.

Due to the configuration and functions of the present invention as described hereinabove, even when the communication parameters of an outside apparatus change, the present invention enables settings for passing or blocking communication with an outside apparatus with the apparatus identifier of an outside apparatus as a key as quickly and appropriately as a case in which communication parameters do not change.

### BRIEF DESCRIPTION OF THE DRAWINGS

FIG. 1 is a block diagram showing the connection relations between the constituent components of a communication control system in an exemplary embodiment according to the present invention;

FIG. 2A is a block diagram showing an example of the configuration of the hardware of the terminal device shown in FIG. 1;

FIG. 2B is a block diagram showing an example of the configuration of the hardware of the outside apparatus shown in FIG. 1;

FIG. 3 is an explanatory view showing the constituent content of a storage device in FIG. 2A and is an example that corresponds to the first exemplary embodiment;

FIG. 4 is a function block diagram showing the functional configuration of a terminal device that forms a principal part of the first exemplary embodiment according to the present invention;

FIG. 5 is a flow chart showing the operations of the terminal device of FIG. 4;

FIG. 6 is an explanatory view of the constituent content of the storage device in FIG. 2A and shows an example corresponding to the second exemplary embodiment;

FIG. 7 is a function block diagram showing the functional configuration of the terminal device that forms a principal part of the second exemplary embodiment according to the present invention;

FIG. 8 is a view in which each of the means in FIG. 7 is made to correspond with a communication control program;

FIG. 9 is a flow chart showing the operation of the terminal device of FIG. 7; and

FIG. 10 is a flow chart that continues from FIG. 9.

### EXPLANATION OF REFERENCE NUMBERS

10 terminal device
11, 21 central processing unit
12, 22 storage device
12a, 22a main storage unit
12b, 22b secondary storage unit
13, 23 communication interface device
14 output device
15 input device
20 outside apparatus (existence information transmission means)
101 communication means
102 apparatus control means
103 apparatus discovery means (authentication means, reliability determination means)
104 apparatus identifier acquisition means
105 communication parameter acquisition means
106 policy determination means
107 communication selection rule combining means
108 firewall means (communication pass control means)
109 old communication selection rule deleting means (communication selection rule updating means)
110 communication selection rule setting means (communication selection rule updating means)
111 application means
112 user interface means
113 policy inquiry means
121 communication control program storage area
122 policy registration DB (policy storage means)
123 communication selection rule registration DB (communication selection rule storage means)

### BEST MODE FOR CARRYING OUT THE INVENTION

A detailed explanation next follows regarding the best mode of carrying out the invention with reference to the accompanying figures.

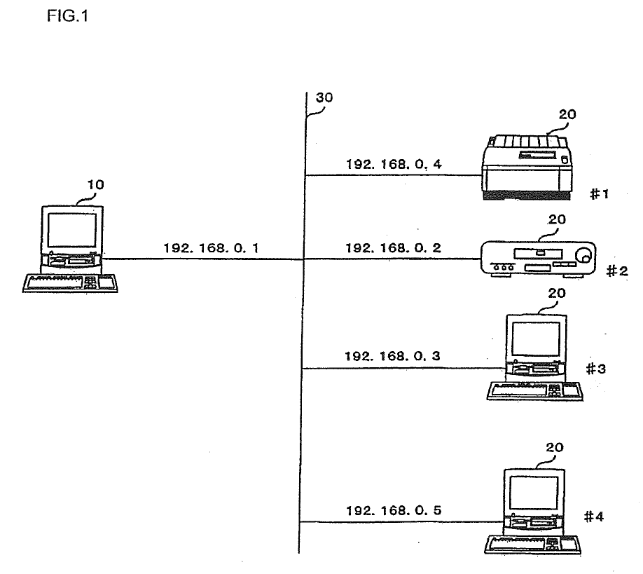

As shown in FIG. 1, the communication control system of an exemplary embodiment of the present invention includes terminal device 10 and outside apparatus 20. Terminal device 10 and outside apparatus 20 are connected by way of communication network 30, which is the communication means. In the present exemplary embodiment, a case is shown in which a plurality of outside apparatuses 20 are provided. The communication control means of terminal device 10 corresponds to the communication control device of the present invention.

### First Exemplary Embodiment

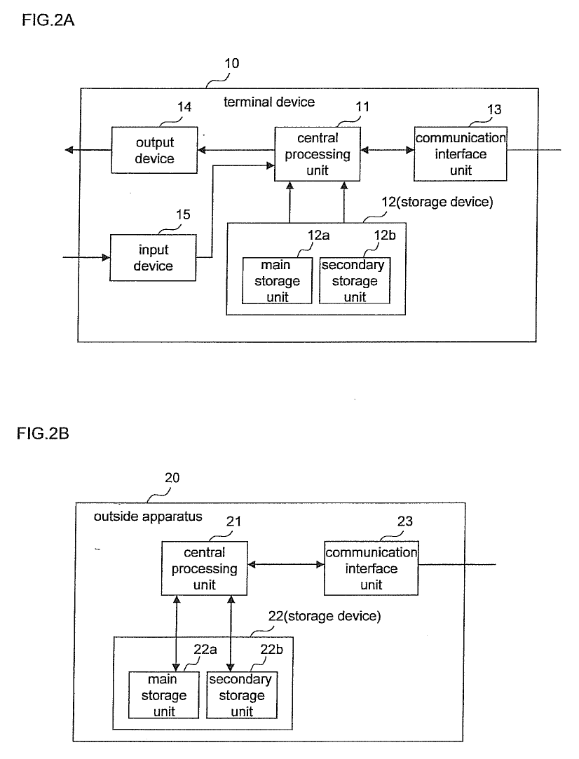

As shown in FIG. 2A, terminal device 10 in the first exemplary embodiment of the present invention includes: central processing unit 11 that operates under the control of a program, storage device 12, communication interface device 13 for transmitting and receiving data over communication network 30, output device 14 for presenting information to the user, and input device 15 for accepting data input from the user. Storage device 12 is composed of main storage unit 12a for holding programs for controlling central processing unit 11 and data that the programs control and secondary storage unit 12b for permanently holding programs and data when, for example, the power supply is cut off. In addition, this terminal device 10 is in a form connected to outside apparatuses by way of communication network 30 as shown in FIG. 1.

As shown in FIG. 2B, a typical configuration of outside apparatus 20 includes at least: central processing unit 21 that operates under the control of a program, storage device 22, communication interface device 23 that transmits and receives data over communication network 30; output device 24 for presenting information to the user; and input device 25 for accepting data input from the user, and in some cases includes other devices according to the type of outside apparatuses 20. Storage device 22 is made up from main storage unit 22a for holding programs that control central processing unit 21 and data that the programs control and secondary storage unit 12b for permanently holding programs and data when, for example, the power supply is cut off. If outside apparatus 20 is, for example, a printing apparatus that can be connected to the network, it may be a printing device composed of a printing unit and a paper-feed unit (for example, #1 outside apparatus 20 shown in FIG. 1).

Central processing unit 11 of terminal device 10 described above executes prescribed operations in accordance with a communication control program described below that is stored in storage device 12 and realizes each of the functional means described hereinbelow.

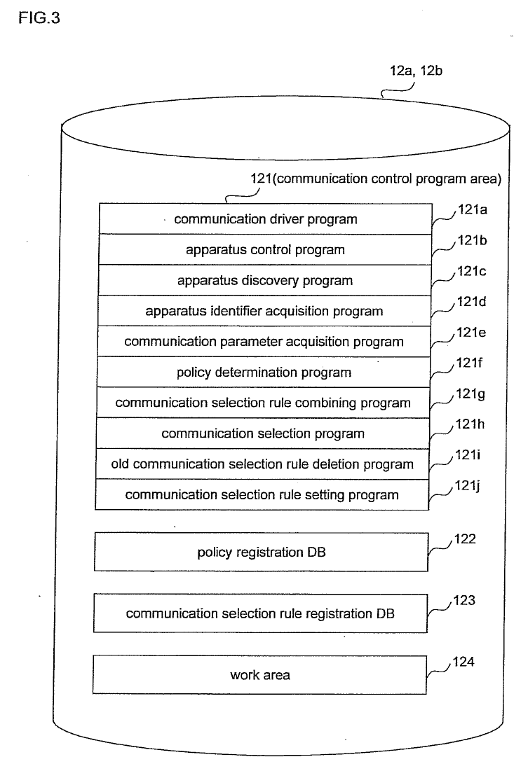

In this case, storage device 12 includes main storage unit 12a and secondary storage unit 12b that is used when the control programs that were stored in main storage unit 12a have been deleted when the power supply is cut off. As shown in FIG. 3, main storage unit 12a and secondary storage unit 12b include: communication control program area 121 for storing communication control programs, policy registration database (policy registration DB) 122, communication selection rule registration database (communication selection rule registration DB) 123, and work area 124 for storing, for example, the apparatus search results that will be explained hereinbelow.

The communication control programs that are stored in the above-described communication control program area 121 are composed of: communication driver program 121a, apparatus control program 121b, apparatus discovery program 121c, apparatus identifier acquisition program 121d, communication parameter acquisition program 121e, policy determination program 121f, communication selection rule combining program 121g, communication selection program 121h, old communication selection rule deleting program 121i, and communication selection rule setting program 121j.

Policy registration DB 122 stores policy determination data. These policy determination data describe policies indicating whether to pass or block communication with outside apparatus 20 and apparatus identifiers uniquely assigned to outside apparatuses 20.

Communication selection rule registration DB 123 stores communication selection rule data that describe rules stipulating the operations for causing terminal device 10 to pass or block communication with respect to outside apparatus 20 (hereinbelow referred to as “communication selection rules”). Apparatus identifiers for uniquely identifying outside apparatuses 20, communication parameters assigned to outside apparatuses, and policies are described in these communication selection rule data.

Communication interface device 13 transmits transmission packets to and receives transmission packets from outside apparatus 20 by way of communication network 30. Output device 14 supplies the user with, for example, data of transmission packets that have been received by way of communication network 30 and data that have been processed in devices. Input device 15 transfers information or data that have been received as input from the outside to central processing unit 11.

As shown in FIG. 2B, previously described outside apparatus 20 is of a configuration that includes central processing unit 21, main storage unit 22, and communication interface device 23.

Of these components, central processing unit 21 executes operations in accordance with the communication control programs (not shown) that are stored in storage device 22. As previously described, storage device 22 includes main storage unit 22a and secondary storage unit 22b that is used when the power supply is cut off and the control program and data that were stored in main storage unit 22a are deleted. Communication interface device 23 transmits information to and receives information from terminal device 10 by way of communication network 30.

Previously described central processing unit 11 of terminal device 10 is provided with the function of executing prescribed information processing in accordance with each program shown in FIG. 3. The programs shown in FIG. 3 are: communication driver program 121a, apparatus control program 121b, apparatus discovery program 121c, apparatus identifier acquisition program 121d, communication parameter acquisition program 121e, policy determination program 121f, communication selection rule combining program 121g, communication selection rule combining program 121h, old communication selection rule deleting program 121i, and communication selection rule setting program 121j.

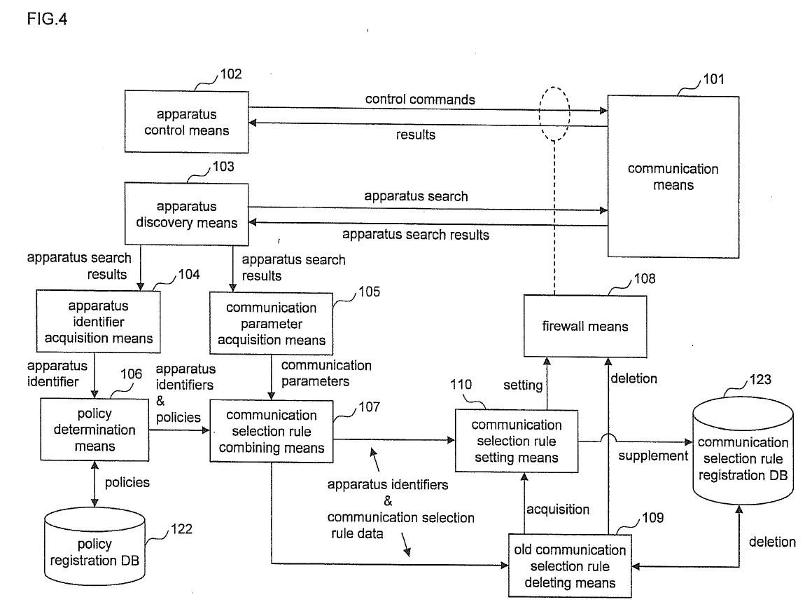

By executing the above-described programs, this central processing unit 11 is therefore of a configuration that is essentially provided with each of the constituent elements that execute the content corresponding to respective programs, i.e., communication means 101, apparatus control means 102, apparatus discovery means 103, apparatus identifier acquisition means 104, communication parameter acquisition means 105, policy determination means 106, communication selection rule combining means 107, firewall means 108, old communication selection rule deleting means 109, and communication selection rule setting means 110, as shown in FIG. 4.

These means are described hereinbelow.

Communication means 101 executes processing in accordance with control commands that have been received as input from apparatus control means 102 and supplies the results as output to apparatus control means 102. For example, when communication means 101 receives from apparatus control means 102 a control command to transmit an apparatus search to discover outside apparatus 20, communication means 101 transmits the apparatus search that was received as input from apparatus discovery means 103 to communication network 30. When communication means 30 receives the results (hereinbelow referred to as “apparatus search results”) for the apparatus search that was previously transmitted from outside apparatus 20, communication means 101 both supplies these data to apparatus discovery means 103 and supplies the result that reception is completed to apparatus control means 102.

Apparatus control means 102 is a means for controlling outside apparatuses and, by executing the apparatus control program that is stored in storage device 12, sends control commands to outside apparatuses by way of communication means 101.

Apparatus discovery means 103 supplies an apparatus search that is stored in work area 124 of storage device 12 to communication means 101, and further, supplies the apparatus search results for the apparatus search that is stored in work area 124 to apparatus identifier acquisition means 104 and communication parameter acquisition means 105.

Apparatus identifier acquisition means 104 analyzes the apparatus search results that are received as input from apparatus discovery means 103 and acquires the apparatus identifier that uniquely specifies outside apparatus 20. In this case, the apparatus identifier is assumed not to be a value assigned on an ad hoc basis (specially), and instead, is assumed not to change even when the power to outside apparatus 20 is cut off and then reintroduced.

Communication parameter acquisition means 105 analyzes the apparatus search results that are received as input from apparatus discovery means 103 and acquires communication parameters in which is described information necessary for communication with outside apparatus 20. These communication parameters may be values assigned on an ad hoc basis. In other words, the potential exists for the values of the communication parameters to change when the power supply of outside apparatus 20 is cut off and then reapplied.

Policy determination means 106 searches for policy determination data that are stored in policy registration DB 122 using an apparatus identifier that is received as input from apparatus identifier acquisition means 104 as a key to determine whether policy determination data in which this key is described are stored or not. Upon determining that policy determination data that include the relevant key are stored, policy determination means 106 reads these policy determination data and supplies the policy and apparatus identifier that are described in these data to communication selection rule combining means 107. When policy determination means 106 determines that policy determination data that include the relevant key are not stored, policy determination means 106 supplies the policy received as input from the communication network administrator and the apparatus identifier that was previously received to communication selection rule combining means 107.

Based on the apparatus identifier and communication policy that were received from policy determination means 106 and the communication parameters that were acquired from communication parameter acquisition means 105, communication selection rule combining means 107 produces communication selection rule data in which communication selection rules are described in accordance with a format that can be understood by firewall means 108. Communication selection rule combining means 107 further supplies the communication selection rule data that have been produced to old communication selection rule deleting means 109 and communication selection rule setting means 110.

Firewall means (communication pass control means) 108 either passes or blocks communication with outside apparatus 20 that corresponds to the communication parameters in accordance with the communication selection rules that are set by communication selection rule setting means 110 that will be described hereinbelow. In this case, even when terminal device 10 has the function of relaying communication, firewall means 108 passes or blocks communication in accordance with the communication selection rules.

When there is no agreement with any of communication selection rules that have been set, firewall means 108 blocks the connection of communication. It is further assumed that firewall means 108 is set in advance to pass data relating to the transmission of an apparatus search and the reception of apparatus search results.

Old communication selection rule deleting means (communication selection rule updating means) 109 searches whether the apparatus identifier that is described in communication selection rule data that are received as input is stored in main storage unit 12a (secondary storage unit 12b when the power supply is down) of storage device 12. When, as a result of this search, the apparatus identifier is found to be stored, the relevant communication selection rule data are recognized to be old communication selection rule data, not only are these data deleted from main storage unit 12a and secondary storage unit 12b, but the old communication selection rules that were described in the old communication selection rule data set in firewall means 108 are released. In this case, the old communication selection rules are communication selection rules that can no longer be applied to this outside apparatus 20 due to a change in the communication parameters of outside apparatus 20 specified by the apparatus identifier.

Communication selection rule setting means (communication selection rule updating means) 110 is a means for setting the communication selection rules that are produced by communication selection rule combining means 107 in firewall means 108 and sets the communication selection rules to firewall means 108 in accordance with the setting method of communication selection rules to firewall means 108. In addition, communication selection rule setting means 110 stores the communication selection rules that have been set to firewall means 108 in communication selection rule storage means (communication selection rule storage/registration DB 123) together with the apparatus identifier. The method of setting communication selection rules to firewall means 108 differs according to each firewall means and may entail, for example, writing the communication selection rules to a specific firewall means or supplying a specific API.

Communication selection rule storage/registration DB (communication selection rule storage means) 123 is a means for storing communication selection rules with apparatus identifiers as keys (a registration database), and when there is a request to register an apparatus identifier and communication selection rules, writes the set of apparatus identifier and communication selection rules to storage device 12. In addition, when there is an inquiry for communication selection rules with an apparatus identifier as a key, the communication selection rules that are a set with the apparatus identifier are searched from storage device 12. When the communication selection rules that form a set with the apparatus identifier are found, these communication selection rules are returned as the response to the inquiry, and when the rules are not found, the response is “no communication selection rules.” In addition, when there is a request to delete communication selection rules with an apparatus identifier as a key, the set of apparatus identifier and communication selection rules is deleted from storage device 12.

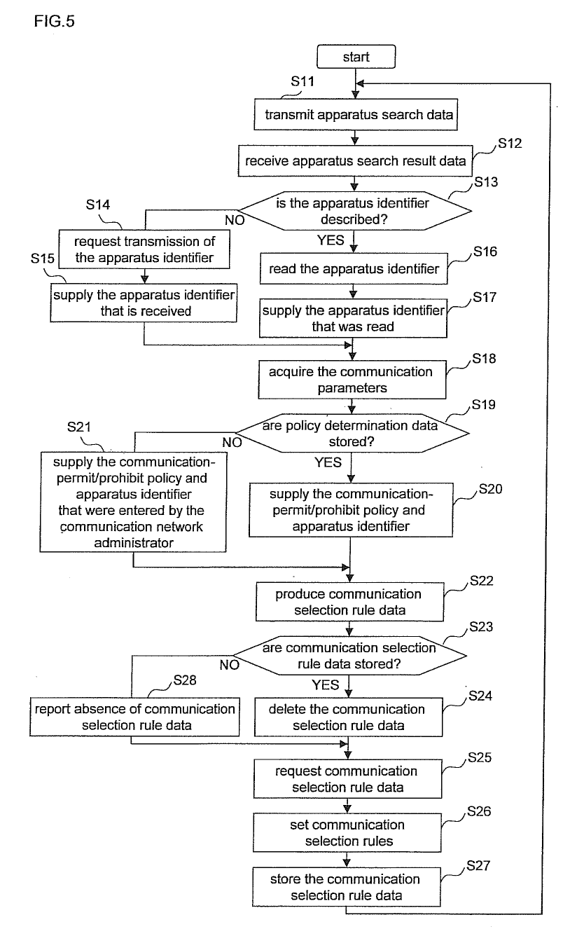

Explanation next regards the operations of the communication control system in the above-described first exemplary embodiment based on the flow chart of FIG. 5.

Apparatus discovery means 103 first transmits an apparatus search to communication network 30 by way of communication means 101 (Step S11). Apparatus discovery means 103 then, upon receiving as input the apparatus search results for the apparatus search that was transmitted from communication means 101 (Step S12), supplies these results to apparatus identifier acquisition means 104 and communication parameter acquisition means 105.

Apparatus identifier acquisition means 104, upon receiving the apparatus search results, determines whether the apparatus identifier of outside apparatus 20 is described in these data (Step S13) and upon determining that the apparatus identifier is not described (Step S13: NO), supplies a request to apparatus discovery means 103 to transmit the apparatus identifier of the relevant outside apparatus 20.

Apparatus discovery means 103 thereupon transmits the request to transmit the apparatus identifier for the relevant outside apparatus 20 to communication network 30 by way of communication means 101 (Step S14). Apparatus discovery means 103, upon subsequently receiving as input from communication means 101 the apparatus identifier of the relevant outside apparatus 20 that has been received, supplies the apparatus identifier to policy determination means 106 (Step S15) and advances processing to Step S18.

When apparatus identifier acquisition means 104 determines that the apparatus identifier of outside apparatus 20 is described in the apparatus search results in the previously described Step S13, (Step S13: YES), apparatus identifier acquisition means 104 reads the apparatus identifier that is described in these data (Step S16) and supplies this apparatus identifier to policy determination means 106 (Step S17).

Upon receiving the apparatus search results from apparatus discovery means 103, communication parameter acquisition means 105 analyzes these results, acquires the communication parameters of relevant outside apparatus 20 (Step S18), and supplies the acquired communication parameters to communication selection rule combining means 107. In addition, there are three types of communication parameters that are acquired: communication parameters that are described in the apparatus search results that are received as input, communication parameters that are deduced from information of relevant outside apparatus 20 outside the apparatus search results when these results are received, and a combination of these two types.

Policy determination means 106 searches the policy determination data that are stored in storage device 12 with the acquired apparatus identifier as key and determines whether there are policy determination data in which this key is described (Step S19). When policy determination means 106 determines that there are policy determination data in which the relevant key is described (Step S19: YES), policy determination means 106 reads these policy determination data, supplies communication selection rule combining means 107 with the policies described in these policy determination data and the apparatus identifier that was previously applied as input (Step S20), and advances processing to Step S22.

On the other hand, upon determining that there are no policy determination data in which the relevant key is described (Step S19: NO), i.e., upon determining that the apparatus identifier that was received as input has not been previously received, policy determination means 106 supplies communication selection rule combining means 107 with policies received from the communication network administrator and the apparatus identifier that was previously received (Step S21).

Based on the apparatus identifier and policies that have been received as input from policy determination means 106 and communication parameters acquired from communication parameter acquisition means 105 described above, communication selection rule combining means 107 then produces communication selection rule data in accordance with a format that can be understood by firewall means 108 (Step S22). Communication selection rule combining means 107 then supplies the selection rule data that have been produced to old communication selection rule deleting means 109.

Old communication selection rule deleting means 109 then searches for communication selection rule data stored in main storage unit 12a (communication selection rule data stored in secondary storage unit 12b when the power supply has been interrupted) of storage device 12 using as a key the apparatus identifier of relevant outside apparatus 20 that is described in the communication selection rule data that were received as input and determines whether relevant communication selection rule data are stored or not in storage device 12 (Step S23).

If old communication selection rule deleting means 109 determines that communication selection rule data in which the apparatus identifier of relevant outside apparatus 20 is described are stored in storage device 12 (Step S23: YES), old communication selection rule deleting means 109 both deletes the communication selection rule data from storage device 12 (Step S24) and supplies a request to firewall means 108 to release the old communication selection rules that are set.

In this way, firewall means 108 both releases settings of old communication selection rules that are already set and supplies selection rule setting means 110 with an indication that the old communication selection rules have been released.

Upon receiving this information, communication selection rule setting means 110 immediately issues a request for communication selection rule data to communication selection rule combining means 107 (Step S25). Subsequently, having received communication selection rule data as input from communication selection rule combining means 107, communication selection rule setting means 110 both sets the communication selection rules that are described in the data that have been received to firewall means 108 (Step S26) and stores the communication selection rule data in storage device 12 (Step S27), and then again moves processing to Step S11 and continues the same processing as described above.

If old communication selection rule deleting means 109 determines in Step S23 that communication selection rule data in which the apparatus identifier of relevant outside apparatus 20 is described are not stored in storage device 12 (Step S23: NO), old communication selection rule deleting means 109 indicates this determination to communication selection rule setting means 110 (Step S28) and moves processing to Step S25.

As described hereinabove, a configuration is adopted in this first exemplary embodiment in which communication selection rules are produced in accordance with communication parameters acquired from search results and set in firewall means 108, whereby communication selection rules can be set in firewall means 108 such that only communication with an outside apparatus that corresponds to the search results is allowed to pass.

Further, in the above-described first exemplary embodiment, a configuration is adopted whereby, when acquisition occurs for a specific apparatus identifier for the first time, a communication permission/prohibition policy is once determined for the outside apparatus that accords with the relevant apparatus identifier, and for second and succeeding instances of acquisition, a communication permission/prohibition policy is determined with the same values as the communication permission/prohibition policy that was acquired the first time, whereby, even in the event of a change in the communication parameters, the communication selection rules that are set in firewall means 108 can be made to correspond to the changes of communication parameters.

Thus, according to the above-described first exemplary embodiment, communication selection rule combining means 107 combines communication selection rules based on policies determined by policy determination means 106 and communication parameters that are acquired by apparatus identifier acquisition means 104, whereby settings for the passage or blockage of communication with outside apparatus 20 can be carried out appropriately regardless of changes in the communication parameters of outside apparatus 20.

### Second Exemplary Embodiment

Explanation next regards the communication control system of the second exemplary embodiment according to the present invention. Parts that are identical to the previously described first exemplary embodiment are given the same reference numbers.

In this second exemplary embodiment, the constituent parts of the apparatus of the system have substantially the same configuration as the previously described first exemplary embodiment (FIGS. 2A and 2B), and the present exemplary embodiment differs from the first exemplary embodiment in that the user's intentions are incorporated in the first determination of a pass/prohibition policy.

Details of the configuration of the second exemplary embodiment are next explained.

In the second exemplary embodiment, as in the above-described first exemplary embodiment (FIG. 2A), terminal device 10 includes: central processing unit 11 that operates according to program control; storage device 12 composed of main storage unit 12a for holding programs for controlling this central processing unit 11 and data that are processed by the programs and secondary storage unit 12b for permanently holding programs and data when the power supply is cut off; communication interface device 13 for transmitting and receiving data over communication network 30 (for example, see FIG. 1); output device 14 for presenting information to the user; and input device 14 for accepting data input from the user. In addition, terminal device 10 is connected to outside apparatus 20 by way of communication network 30.

As in the previously described first exemplary embodiment (FIG. 2B), a typical configuration of the above-described outside apparatus 20 is provided with at least: central processing unit 21 that operates under the control of a program; storage device 22 that is composed of main storage unit 22a for holding programs for controlling this central processing unit 21 and data that are processed by the programs and secondary storage unit 22b for permanently holding programs and data when the power supply is cut off; and communication interface device 23 for transmitting and receiving data over communication network 30 (for example, see FIG. 1).

As the configuration of outside apparatus 20, other devices are further included in some cases depending on the type of outside apparatus 20. For example, in the case of a printer apparatus that can be connected to a network, outside apparatus 20 is a printing device composed of a printing unit and paper-feed unit.

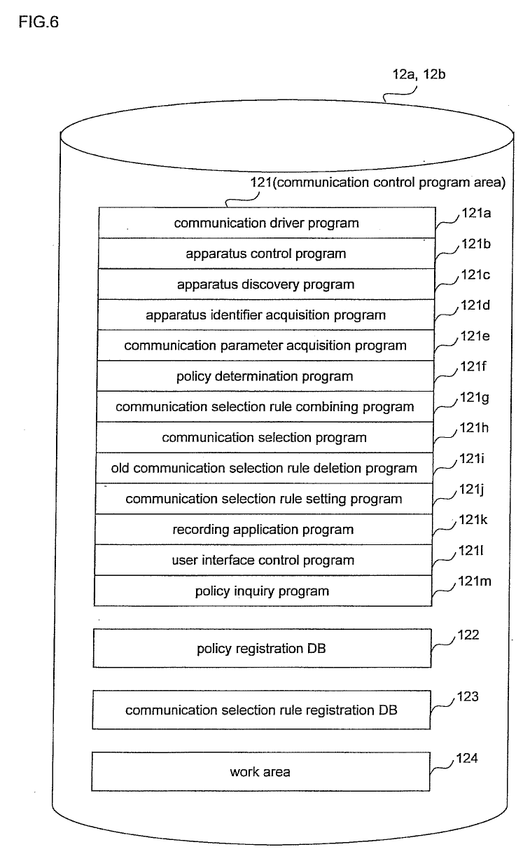

Storage device 12 in the above-described second exemplary embodiment stores in communication control program area 121 processing programs such as shown in FIG. 6, i.e., communication driver program 121a, apparatus control program 121b, apparatus discovery program 121c, apparatus identifier acquisition program 121d, communication parameter acquisition program 121e, policy determination program 121f, communication selection rule combining program 121g, communication selection program 121h, old communication selection rule deleting program 121i, communication selection rule setting program 121j, recording application program 121k, user interface control program 121l, and policy inquiry program 121m.

Central processing unit 11 of terminal device 10 in this second exemplary embodiment is provided with the capability to execute prescribed information processing that is incorporated in each program in accordance with each program shown in FIG. 6, i.e., communication driver program 121a, apparatus control program 121b, apparatus discovery program 121c, apparatus identifier acquisition program 121d, communication parameter acquisition program 121e, policy determination program 121f, communication selection rule combining program 121g, communication selection program 121h, old communication selection rule deleting program 121i, and communication selection rule setting program 121j.

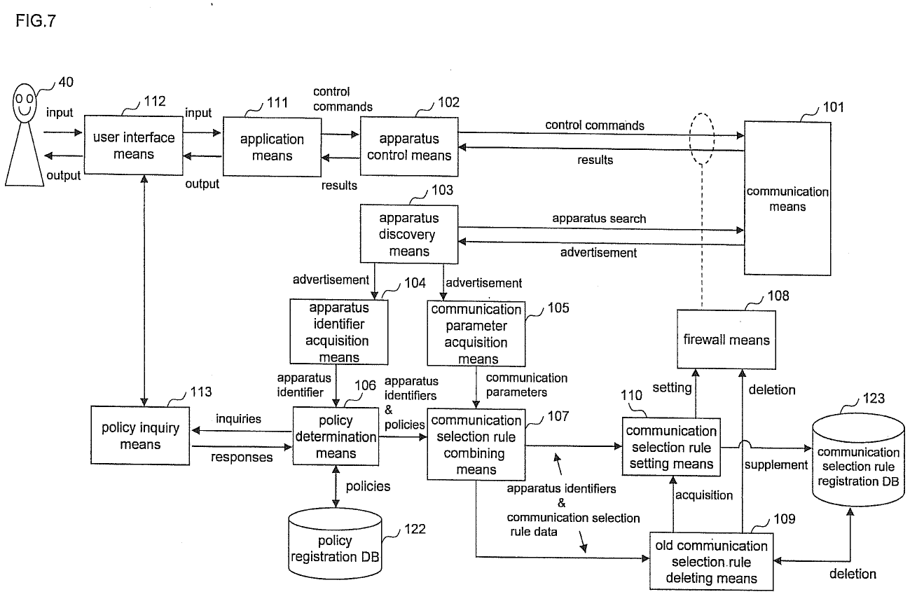

By executing each of the above-described programs, the previously described central processing unit 11 is of a configuration that is effectively provided with each of the constituent elements as shown in FIG. 7 that execute the content corresponding to each of the relevant programs, these elements being: communication means 101, apparatus control means 102, apparatus discovery means 103, apparatus identifier acquisition means 104, communication parameter acquisition means 105, policy determination means 106, communication selection rule combining means 107, firewall means 108, old communication selection rule deleting means 109, and communication selection rule setting means 110. In addition, central processing unit 11 is of a configuration that is effectively provided with application means 111, user interface means 112, and policy inquiry means 113.

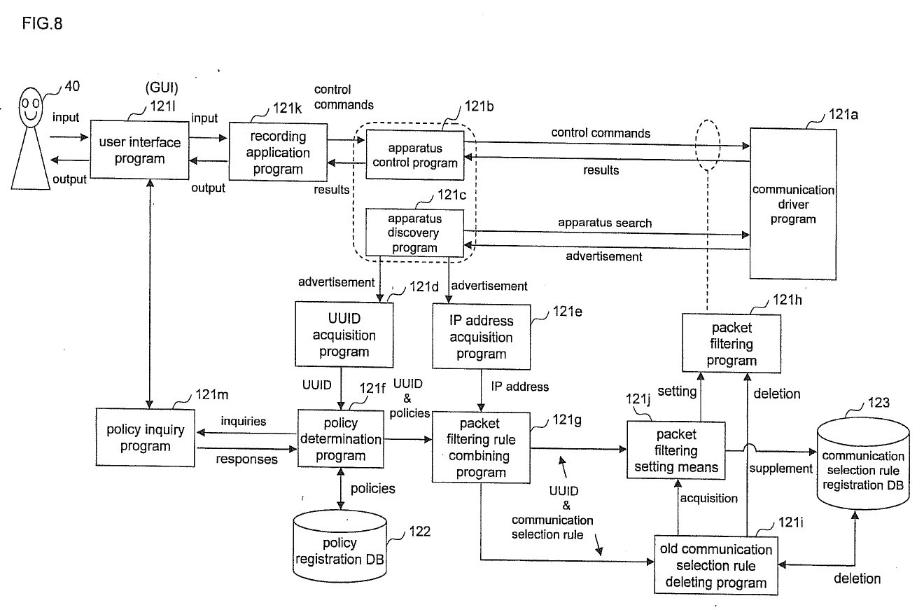

Here, FIG. 8 is a figure in which each of the means in FIG. 7 is placed in correspondence with a communication control program.

Each of the means is described hereinbelow.

As previously stated, by operating each of the programs on above-described terminal device 10, each of the above-described functional means executes each of the functions of the content presented below (FIG. 7).

Application means 111 is a means for realizing on terminal device 10 an application service that is convenient for user 40. Operations in the form of a dialogue are accepted from user 40 through user interface means 112 and the existence of outside apparatus 20 is detected through apparatus discovery means 103. In addition, operation is realized in which outside apparatus 20 that is detected through apparatus control means 102 is controlled, in which control is effected by outside apparatus 20 that is detected through apparatus control means 102, or in which both types of control occur.

User interface means 112 is a means for realizing operation in the form of a dialogue with user 40. Information to be presented to user 40 is taken in from application means 111 and policy inquiry means 113, and information is presented to the user through output device 14. In addition, information applied as input from the user is accepted through input device 15 and transferred to application means 111 and policy inquiry means 113.

More specifically, this user interface means 112 accepts input and output in the form of a dialogue with the user by way of a display or keyboard and mouse. In other words, user interface means 112 receives information to be presented to the user from application means 111 and policy inquiry means 113 and presents this information that is received to the user by way of output device 14. In addition, user interface means 112 receives as input information that has been applied by the user by way of input device 15 and supplies this information to application means 111 and policy inquiry means 113.

The software that makes up application means 111, policy inquiry means 113, and user interface means 112 appropriately mediates whether the information applied as input by the user is transferred to application means 111 or policy inquiry means 113. The details of this mediation are already known to those expert in the art (for example, technicians dealing with the user interface technology in computer devices) and a detailed explanation is therefore here omitted.

Apparatus control means 102 is a means that controls outside apparatus 20, that accepts control from outside apparatus 20, or that both controls and is controlled. Upon receiving a control command from application means 111, apparatus control means 102 converts the control command to a format suitable for transmitting to outside apparatus 20 by way of communication network 30, and transmits the control command through communication means 101 to outside apparatus 20.

If outside apparatus 20 returns control results, apparatus control means 102 converts the control results to a format suitable for transferring to application means 111 and transfers the control results to application means 111. Alternatively, apparatus control means 102 receives a control command from outside apparatus 20, converts the control command to a format appropriate for transferring to application means 111, and transfers the control command to application means 111. If application means 111 returns control results, apparatus control means 102 converts the control results to a format appropriate for transmitting to outside apparatus 20 by way of communication network 30 and transmits the control results through communication means 101 to outside apparatus 20.

Apparatus discovery means 103 is a means for discovering outside apparatus 20 that is connected to terminal device 10 by way of communication network 30. Outside apparatus 20 is discovered by the reception of an “advertisement” (existence report) from outside apparatus 20 through communication means 103. An “advertisement” is information that a particular apparatus transmits to apparatuses other than itself that are connected by way of communication network 30 to report that it is capable of linkage.

Advertising includes a case in which an outside apparatus periodically advertises on communication network 30 (broadcasts or multicasts) and a case in which apparatus discovery means 103 advertises a search on communication network 30 and outside apparatus 20 responds to this by returning an advertisement. Details regarding these cases are already known to those skilled in the art (in particular, technicians dealing with apparatus-linking system technology), and a detailed explanation is therefore here omitted.

Communication means 101 is a means for transmitting data to and receiving data from functional means in terminal device 10 and outside apparatuses 20 by way of communication network 30 and is realized by the linked operation of driver software that operates on terminal device 10 and communication interface device 13 that is a constituent element of terminal device 10.

More specifically, this communication means 101 executes processing in accordance with control commands received as input from apparatus control means 102 and supplies the results of processing to apparatus control means 102. For example, upon receiving a control command to transmit an apparatus search in which information necessary for discovering outside apparatus 20 is described from apparatus control means 102, this communication means 101 transmits the apparatus search received from apparatus discovery means 103 to communication network 30. Upon receiving from outside apparatus 20 the results for an apparatus search that was previously transmitted (this information corresponds to the above-described “advertisement” and is hereinbelow referred to as “advertisement.”), communication means 30 both supplies an advertisement to apparatus discovery means 103 and supplies the result that reception is completed to apparatus control means 102.

Apparatus identifier acquisition means 104 is a means for acquiring apparatus identifiers and analyzes the advertisement received by apparatus discovery means 103 and acquires information that can uniquely specify outside apparatus 20 (apparatus identifier).

Here, an apparatus identifier is assumed not to be a value assigned on an ad hoc basis, and for example, is assumed not to change even when the power supply of outside apparatus 20 is cut off and then reapplied. A candidate for such an apparatus identifier is described in an example to be described hereinbelow.

Communication parameter acquisition means 105 is a means for acquiring communication parameters of outside apparatus 20, and analyzes advertisements received by apparatus discovery means 103 to acquire information that can specify communication with outside apparatus 20 (communication parameters). A communication parameter is information that can determine whether the destination of data that are transmitted by communication means 101 to communication network 30 is a specific outside apparatus 20 or not, and moreover, is information that can determine whether the transmission origin of data that communication means 101 receives from communication network 30 is a specific outside apparatus 20. Here, communication parameters may be values that are assigned on an ad hoc basis.

As a result, when the power supply of outside apparatus 20 is cut off and then reapplied, the values may change. A candidate for a communication parameter is shown in the examples.

Policy determination means 106 is a means for determining communication-permit/prohibit policies according to apparatus identifier, the communication-permit/prohibit policies here being instructions to pass or block communication. Policy determination means 106 acquires apparatus identifiers from apparatus identifier acquisition means 104 and submits an inquiry to policy registration DB (policy storage means) 122 using an apparatus identifier as a key. When policy registration DB 122 returns a communication-permit/prohibit policy, policy determination means 106 takes the communication-permit/prohibit policy returned by policy registration DB 122 as the communication-permit/prohibit policy that accords with the apparatus identifier.

When policy registration DB (policy storage means) 122 responds with “no communication-permit/prohibit policy,” policy determination means 106 transfers the apparatus identifier to policy inquiry means 113 and receives from policy inquiry means 113 the communication-permit/prohibit policy that was the user's response. Policy determination means 106 then issues a registration request to policy storage means 122 using the apparatus identifier as key for the communication-permit/prohibit policy that was the user's response and takes the communication-permit/prohibit policy that was the user's response as the communication-permit/prohibit policy that accords with the apparatus identifier.

In other words, this policy determination means 106 determines the policies of outside apparatuses 20 for each apparatus identifier. More specifically, this policy determination means 106 performs a search regarding policy determination data that are stored in policy registration DB 122 in storage device 12 with the apparatus identifier received as input from apparatus identifier acquisition means 104 as a key and determines whether policy determination data in which this key is described are stored in policy registration DB 122 or not.

Then, upon determining that policy determination data in which the relevant key is described are stored in policy registration DB 122, policy determination means 106 reads these policy determination data and supplies the policy and apparatus identifier that are described in these data to communication selection rule combining means 107.

Alternatively, if policy determination means 106 determines that policy determination data having the relevant key are not stored, policy determination means 106 both supplies communication selection rule combining means 107 with information according to a policy received from the communication network administrator and the apparatus identifier that was previously received as input, combines policy determination data that take the apparatus identifier as the key item and registers these data in policy registration DB 122.

Policy storage means 122 is a means for storing communication-permit/prohibit policies using apparatus identifiers as keys. When there is a registration request for an apparatus identifier and communication-permit/prohibit policy, the set of apparatus identifier and communication-permit/prohibit policy is written to storage device 12, and when there is an inquiry for a communication-permit/prohibit policy with an apparatus identifier as key, the communication-permit/prohibit policy that forms a set with the apparatus identifier is searched from storage device 12. If a communication-permit/prohibit policy that forms a set with the apparatus identifier is found, this communication-permit/prohibit policy is returned as a response to the inquiry, and if not found, the response “no communication-permit/prohibit policy” is returned.

Policy inquiry means 113 is a means for submitting an inquiry to user 40 whether communication with the apparatus identifier is to be passed or blocked and shows the apparatus identifier to the user, receives the response from user 40, and returns the response results to policy determination means 106. Here, when it is difficult for user 40 to identify outside apparatus 20 by only the apparatus identifier (for example, when the apparatus identifier is simply a string of numbers and user 40 does not understand which outside apparatus 20 is being referred to), supplementary information such as the name of the apparatus may be shown to user 40. This supplementary information may be contained in the original advertisement from which the apparatus identifier has been extracted or can be acquired by inquiring to outside apparatus 20 based on the advertisement.

This policy inquiry means 113 is provided with a function for showing the user the apparatus identifier that is assigned to outside apparatus 20 and then supplying policy determination means 106 with the policy of relevant outside apparatus 20 that is received from the communication network administrator.

Communication selection rule combining means 107 is a means for combining communication-permit/prohibit policies and communication parameters to produce communication selection rules. These communication selection rules refer to information for stipulating the operations of firewall means 108. When the communication parameters of communication that terminal device 10 transmits and receives are for communication with outside apparatus 20 that is designated by a particular apparatus identifier, communication selection rule combining means 107 produces communication selection rules in accordance with a format that firewall means 108 can understand so that firewall means 108 can pass or block the above-described communication in accordance with the communication-permit/prohibit policy.

In other words, based on an apparatus identifier and policy received as input from policy determination means 106 and communication parameters acquired from communication parameter acquisition means 105, communication selection rule combining means 107 produces communication selection rule data that describe communication selection rules for passing or blocking communication with outside apparatus 20 in accordance with a format that firewall means 108 can understand. In addition, communication selection rule combining means 107 supplies the communication selection rule data that have been produced to old communication selection rule deleting means 109 and communication selection rule setting means 110.

Old communication selection rule deleting means 109 is a means for deleting from firewall means 108 old communication selection rules that relate to communication with outside apparatus 20 that is specified by the apparatus identifier. The old communication selection rules here referred to are communication selection rules that can no longer be applied to communication with outside apparatus 20 that is specified by an apparatus identifier because the communication parameters of outside apparatus 20 that is specified by the apparatus identifier have changed. When old communication selection rule deleting means 109 issues an inquiry to communication selection rule storage means 123 using the apparatus identifier as a key and old communication selection rules are returned, old communication selection rule deleting means 109 deletes the old communication selection rules from communication selection rule storage means 123 and releases the setting of the old communication selection rules from firewall means 108.

More specifically, this old communication selection rule deleting means (communication selection rule updating means) 109 searches whether or not communication selection rule data having the apparatus identifier that is described in communication selection rule data that was received as input are stored in main storage unit 12a of storage device 12. If as a result it is determined that such data are stored, old communication selection rule deleting means 109 recognizes the relevant communication selection rule data to be old communication selection rule data and both deletes these data from main storage unit 12a and secondary storage unit 12b and releases the old communication selection rules that are described in the old communication selection rule data that are set in firewall means 108.

Here, old communication selection rules are communication selection rules that can no longer be applied to outside apparatus 20 that is specified by an apparatus identifier due to changes of the communication parameters of this outside apparatus 20.

In addition, communication selection rule storage means 123 is a means for storing communication selection rules with apparatus identifiers as keys. When there is a registration request for an apparatus identifier and communication selection rules, the set of apparatus identifier and communication selection rules is written to storage device 12, and when there is an inquiry for communication selection rules with an apparatus identifier as a key, the communication selection rules that form a set with the apparatus identifier are searched from main storage unit 12a or secondary storage unit 12b. If communication selection rules that form a set with the apparatus identifier are found, these communication selection rules are returned as a response to the inquiry, and when not found, the response is “no communication selection rules.” When there is a request to delete the communication selection rules with the apparatus identifier as a key, the set of the apparatus identifier and communication selection rules is deleted from memory.

Communication selection rule setting means 110 is a means for setting communication selection rules that have been produced by communication selection rule combining means 107 in firewall means 108, the communication selection rules being set in firewall means 108 in accordance with the method of setting the communication selection rules in firewall means 108. In addition, the communication selection rules that are set in firewall means 108 are stored in communication selection rule storage means 123 together with an apparatus identifier. In addition, the method of setting communication selection rules in firewall means 108 differs according to each of the firewall means 108 and may take the form of, for example, writing the communication selection rules into a specific file or calling for a specific API.

In other words, this communication selection rule setting means (communication selection rule updating means) 110 is provided with functions for both setting in firewall means 108 communication selection rules that are described in communication selection rule data and storing communication selection rule data in main storage unit 12a and secondary storage unit 12b.

Firewall means 108 is a means for limiting access of communication to terminal device 10 or communication from terminal device 10, and passes or blocks communication in accordance with communication selection rules for all or a part of communication that comes into terminal device 10, communication that proceeds from terminal device 10, and communication that passes through terminal device 10 (communication can pass through when terminal device 10 has the function of relaying communication).

More specifically, this firewall means (communication pass control means) 108 passes or blocks communication with outside apparatus 20 that corresponds to communication parameters in accordance with communication selection rules that are set by means of communication selection rule setting means 110 that will be explained hereinbelow. Firewall means 108 passes or blocks communication in accordance with communication selection rules even when terminal device 10 has the function for relaying communication.

Here, firewall means 108 blocks the connection of communication when there is no match with any of communication selection rules that have been set. In addition, this firewall means 108 is assumed to be set in advance to pass the transmission of apparatus searches and the reception of apparatus search results. Still further, firewall means 108 both accepts the setting of communication selection rules and accepts the deletion of communication selection rules that have been set. An already known component is used for this type of filtering structure.

In this second exemplary embodiment, communication that does not match any of the communication selection rules that have been set is blocked. Still further, settings are made in advance to pass all searches and advertisements.

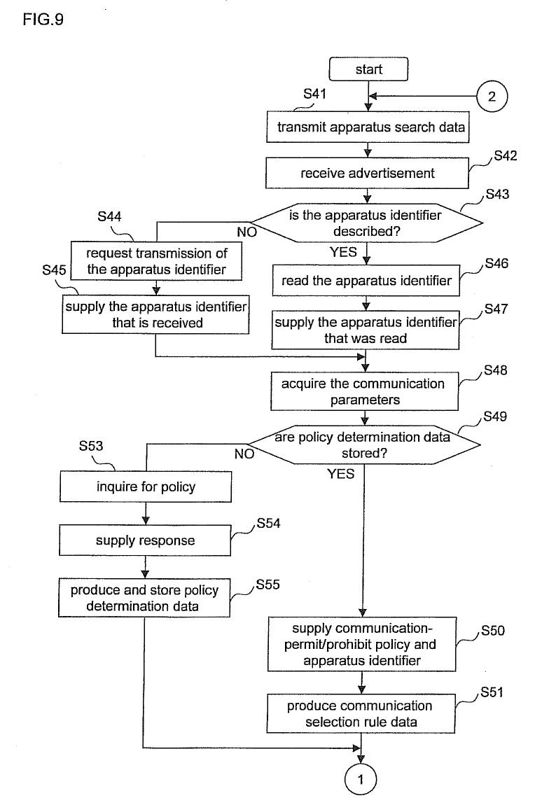

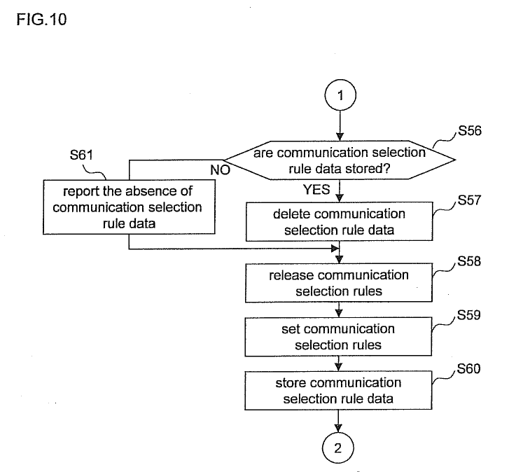

Explanation next regards the operations of the above-described second exemplary embodiment based on the flow chart of FIGS. 9 and 10.

First, apparatus discovery means 103 transmits an apparatus search to communication network 30 by way of communication means 101 (Step S41). Then, upon receiving as input an advertisement of outside apparatus 20 that is, for example, video recorder #2, for an apparatus search that was previously transmitted from communication means 101 (Step S42), apparatus discovery means 103 supplies this advertisement to apparatus identifier acquisition means 104 and communication parameter acquisition means 105. Firewall means 108 is set in advance to pass advertisements. In addition, the advertisement transmitted from #2 outside apparatus 20 is multicast on LAN (Local Area Network) as communication network 30.

Upon the input of the advertisement, apparatus identifier acquisition means 104 determines whether or not the apparatus identifier of outside apparatus 20 is described in these data (Step S43), and if it is determined that the apparatus identifier is not described (Step S43: NO), supplies a request to apparatus discovery means 203 to transmit the apparatus identifier of that outside apparatus 20.

Apparatus discovery means 103 then transmits the transmission request of the apparatus identifier for relevant outside apparatus 20 to communication network 30 by way of communication means 101 (Step S44).

Apparatus identifier acquisition means 104 then supplies the apparatus identifier of relevant outside apparatus 20 that was received as input from apparatus discovery means 103 to policy determination means 106 (Step S45) and proceeds to the processing of Step 48.

Upon determining that the apparatus identifier of outside apparatus 20 is described in an advertisement in Step S43 (Step S43: YES), apparatus identifier acquisition means 104 reads the apparatus identifier described in these data (Step S46) and supplies this apparatus identifier to policy determination means 106 (Step S47).

Upon receiving an advertisement from apparatus discovery means 103, communication parameter acquisition means 105 analyzes this advertisement and acquires the communication parameters of relevant outside apparatus 20 (Step S48), and supplies these communication parameters to communication selection rule combining means 107. The communication parameters that are acquired include items described in the advertisement that was received as input, items that were calculated from information of relevant outside apparatus 20 other than the advertisement when these results were received, and items that are a combination of both of these items.

Policy determination means 106 searches policy determination data stored in policy DB 122 using the acquired apparatus identifier as a key and determines whether or not there are policy determination data in which this key is described (Step S49). If it is determined that there are policy determination data that describe the relevant key (Step S49: YES), policy determination means 106 reads these policy determination data and supplies the policy described in the policy determination data and the apparatus identifier that was previously received as input to communication selection rule combining means 107 (Step S50).

Communication selection rule combining means 107 then, based on the policies and apparatus identifier that have been received as input from policy determination means 106 and the previously described communication parameters acquired from communication parameter acquisition means, produces communication selection rule data in accordance with a format that can be understood by firewall means 108 (Step S51). Communication selection rule combining means 107 next supplies the communication selection rule data that have been produced to old communication selection rule deleting means 109.

For example, when the apparatus identifier of #2 outside apparatus 20 and “permit” are applied as the policy from policy determination means 106, above-described communication selection rule combining means 107 produces communication selection data having content for permitting communication that is provided with the communication parameters that are assigned at the present time (including communication parameters that differ from communication parameters assigned before the power supply is cut off) to the #2 outside apparatus.

In Step S49, when it is determined that there are no policy determination data in which the relevant key is described (Step S49: NO), i.e., when it is determined that the apparatus identifier received as input has been received for the first time, policy determination means 106 issues to policy inquiry means 113 a policy inquiry of outside apparatus 20 to which the apparatus identifier was assigned (Step S53).

Policy inquiry means 113 thereupon submits the above-described inquiry to user interface means 112. User interface means 112 places communication network administrator 40 in a state allowing dialogue, and supplies the above-described inquiry to output device 14.

The response to the above-described inquiry by the communication network administrator, i.e., the policy for relevant outside apparatus 20, is then applied as input to input device 15, and user interface means 112 supplies this response to policy inquiry means 113. Policy inquiry means 113 then supplies the above-described response to policy determination means 106 (Step S54).

Based on the response received as input from policy inquiry means 113 and the apparatus identifier that was previously received, policy determination means 106 combines the policy determination data, stores these data in policy DB 22 (Step S55), and proceeds to the processing of Step S54.

In Step S51, upon the input of communication selection rule data from communication selection rule combining means 107, old communication selection rule deleting means 109 searches the communication selection rule data that are stored in main storage unit 12a (the communication selection rule data stored in secondary storage unit 12b when the power supply has been cut off) of storage device 12 using as a key the apparatus identifier of relevant outside apparatus 20 that is described in these communication selection rule data and determines whether or not the relevant communication selection rule data are stored in storage device 12 (Step S56).

Upon determining that communication selection rule data in which the apparatus identifier of relevant outside apparatus 20 is described are stored in storage device 12 (Step S56: YES), old communication selection rule deleting means 109 both deletes these communication selection rule data from storage device 12 (Step S57) and issues a request to firewall means 108 to release old communication selection rules that are set.

Firewall means 108, upon receiving from old communication selection rule deleting means 109 the request to release old communication selection rules, both releases the setting of the old communication selection rules that are set (Step S58) and reports to selection rule setting means 110 that the old communication selection rules have been released.

Communication selection rule setting means 110 then issues a request for communication selection rule data to communication selection rule combining means 107. After receiving communication selection rule data from communication selection rule combining means 107, communication selection rule setting means 110 not only sets the communication selection rules that are described in these data that have been received to firewall means 108 (Step S59), but also stores the communication selection rule data in storage device 12 (Step S60), moves processing to Step S41, and continues the same processing as described hereinabove.

In Step S56, when old communication selection rule deleting means 109 determines that communication selection rule data in which the apparatus identifier of relevant outside apparatus 20 is described are not stored in storage device 12 (Step S56: NO), old communication selection rule deleting means 109 reports this state to communication selection rule setting means 210 (Step S61) and moves processing to Step S59.

According to this exemplary embodiment, communication selection rule combining means 107 combines communication selection rules based on policies that have been determined by policy determination means 106 and the apparatus identifier that has been acquired by apparatus identifier acquisition means 104, as in the communication control system of the first exemplary embodiment, whereby settings for passing or blocking communication with outside apparatus 20 can be appropriately performed even in the event of a change in the communication parameters as the communication parameters of outside apparatus 20.

In addition, according to this exemplary embodiment, when policies for an apparatus identifier are not stored in policy registration DB 123, policy inquiry means 113 can be caused to perform a policy inquiry for this apparatus identifier, whereby a policy can be determined for an outside apparatus that is received for the first time.

The second exemplary embodiment according to the present invention is configured and functions as described hereinabove and therefore, in addition to exhibiting action and effect that are equivalent to the above-described first exemplary embodiment, can further enable user 40 to set the first determination of communication-permit/prohibit policy, and therefore provides the additional effect of enabling the wishes of user 40 to be effectively reflected in operations.

### Modification

In this modification, the supplementary functions described below have been added to a portion of the constituent elements in the above-described second exemplary embodiment.

First, the above-described outside apparatus 20 is configured to, when transmitting the previously described advertisement, implement an electronic signature in the advertisement and transmit this electronic signature to terminal device 10.

Terminal device 10 described hereinabove is of a configuration in which apparatus discovery means 103 (authentication means and reliability determination means) authenticates the transmission origin of an advertisement that is received from outside apparatus 20. Upon determining as a result of authenticating the transmission origin of the advertisement that the transmission origin of the advertisement cannot be trusted, this apparatus discovery means 103 then discards this advertisement without supplying the advertisement to apparatus identifier acquisition means 104 and communication parameter acquisition means 105. On the other hand, terminal device 10 is of a configuration whereby apparatus discovery means 103, upon determining that the transmission origin of the advertisement can be trusted, supplies a command to policy determination means 106 to cause the policy to forcibly determine “permit.”

The configuration is otherwise identical to that of the second exemplary embodiment described hereinabove.

By adopting this configuration, when it is determined by apparatus discovery means 103 that outside apparatus 20 that is the transmission origin of an advertisement cannot be trusted, firewall means 108 can immediately block this communication that cannot be trusted because this advertisement can be discarded without supplying the advertisement to apparatus identifier acquisition means 104 and communication parameter acquisition means 105.

On the other hand, when it is determined by apparatus discovery means 103 that outside apparatus 20 that is the transmission origin of an advertisement can be trusted, a command is supplied to policy determination means 106 to cause the policy to forcibly determine “permit,” whereby policy determination means 106 can cause firewall means 108 to pass communication relating to outside apparatus 20 without submitting a policy inquiry for this outside apparatus 20 to the communication network administrator by way of policy inquiry means 113 and user interface 112.

Further, the above-described modification is of a configuration whereby, when apparatus discovery means (authentication means and reliability determination means) 103 has determined that outside apparatus 20 that is the transmission origin of an advertisement cannot be trusted, this advertisement is discarded without supplying an advertisement to apparatus identifier acquisition means 104 and communication parameter acquisition means 105, but a configuration is also possible in which apparatus discovery means 103 supplies a command to policy determination means 106 to cause the policy to forcibly determine “block.”

By means of this configuration, a command is supplied to policy determination means 106 to force the policy to determine “block” when it is determined by apparatus discovery means 103 that outside apparatus 20 that is the transmission origin of an advertisement cannot be trusted, and as a result, policy determination means 106 can make firewall means 108 block communication with outside apparatus 20 without submitting a policy inquiry for this outside apparatus 20 to the communication network administration by way of policy inquiry means 113 and user interface 112.

### Example

Explanation next regards an actual example based on FIG. 1 and FIG. 8.

Previously described FIG. 1 shows the network configuration of the present example. Here, the terminal device is assumed to be a PC and the communication network is assumed to be a LAN.

In this FIG. 1, PC 10 that is operated by user 40, video recorder #2 that is controlled by user 40 through PC 10, and invalid PC #3 that, against the intentions of user 40, interferes with PC 10 and video recorder #2, are connected to LAN 30.

In addition, the recent spread of computer viruses raises the potential for situations in which an apparatus such as invalid PC #3 that performs operations against the wishes of user 40 is connected to LAN 30.

These components, PC 10, video recorder #2, and invalid PC #3, carry out IP communication by way of LAN 30. For the sake of convenience in the explanation of the present example, IP address 192.168.0.1 is assigned to PC 10, IP address 192.168.0.2 is assigned to video recorder #2, and IP address 192.168.0.3 is assigned to invalid PC #3.

PC 10 and video recorder #2 are assumed to control each other in accordance with the UPnP standard. Here, invalid PC #3 does not follow the UPnP standard. In other words, invalid PC #3 does not transmit an advertisement to PC 10. In addition, invalid PC #3 does not return a discovery response to a discovery search.

FIG. 8 shows the function blocks in PC 10 of FIG. 1.

Recording application 121k accepts operation of user 40 in the form of a dialogue through GUI (121l). In addition, recording application 121k controls video recorder #2 that is connected by way of LAN 30 through apparatus control program 121b. Recording application 121k may also accept control from video recorder #2. In addition, recording application 121k receives an advertisement through apparatus discovery program 121c for the purpose of detecting that video recorder #2 is connected by way of LAN 30. Here, recording application 121k may also transmit a discovery search to video recorder #2 through apparatus discovery program 121c and substitute an advertisement with the discovery response.

GUI (121l) enables the presentation of information to user 40 by recording application 121k and policy inquiry program 121m or the input of information from user 40 by means of operation of user 40 in the form of a dialogue by way of a display, keyboard and/or mouse that are provided in PC 10.

Apparatus control program 121b transmits control commands to video recorder #2 by way of LAN 30 in accordance with instructions from recording application 121k, and further receives video recorder #2 control results and transfers these results to recording application 121k.

In the present example, apparatus control program 121b is assumed to control video recorder #2 in accordance with the UPnP standard, and the control commands are therefore assumed to be in the format of SOAP (Simple Object Access Protocol) requests and the control results are assumed to be in the format of SOAP responses.

When receiving control from video recorder #2, recording application 121k receives SOAP requests from video recorder #2 and transfers the requests to recording application 121k, and receives control results from recording application 121k and returns this to video recorder #2 in SOAP response format.

Upon receiving an advertisement, apparatus discovery program 121c transfers the advertisement to recording application 121k to report to recording application 121k the existence of an apparatus other than PC 10 on LAN 30. In addition, by multicasting a discovery search on LAN 30 in accordance with the instructions from recording application 121k, apparatus discovery program 121c may also receive the discovery response from video recorder #2 and substitute this discovery response for an advertisement. Even in the absence of instructions from recording application 121k, apparatus discovery program 121c may also periodically multicast a discovery search on LAN 30.

LAN interface 121a connects PC 10 to LAN 30, and apparatus control program 121b and apparatus discovery program 121c perform communication by way of LAN 30 through LAN interface 121a.

UUID acquisition program 121d acquires UUID as the apparatus identifier of an apparatus (video recorder #2 in the case of the present example) from an advertisement. This UUID is standardized by the Open Software Foundation and is also used as the identifier of an apparatus in UPnP (although employed for other uses, such uses have no relation to the present example). In UPnP, the UUID (apparatus identifier) is described as an NT attribute in an advertisement. When a discovery response is substituted for an advertisement, UUID is described in the ST attribute of the discovery response.

IP address acquisition program 121e acquires the IP address “192.168.0.2” of an apparatus (in the case of the present example, video recorder #2) from an advertisement. The IP address uses the IP address of the transmission origin of the advertisement or discovery response. Alternatively, the IP address may also be calculated from the LOCATION attribute in an advertisement and discovery response.

In addition, policy determination program 121f determines a communication-permit/prohibit policy for each UUID (apparatus identifier).

Policy determination program 121f issues a request for a search to policy database 122 with the UUID (apparatus identifier) as a key, and if a communication-permit/prohibit policy is returned from policy database 122, policy determination program 121f takes this as the communication-permit/prohibit policy that is associated with the UUID.

If the response “no communication-permit/prohibit policy” is returned from policy database 122, policy determination program 121f issues a request for a communication-permit/prohibit policy inquiry to policy inquiry program 121m and takes the communication-permit/prohibit policy that is returned as the communication-permit/prohibit policy that is associated with the UUID. Policy determination program 121f further issues a request to policy database 122 at this time to register the communication-permit/prohibit policy with the UUID as a key.

Policy database 122 stores UUID and communication-permit/prohibit policies in association with the UUID as the key and the communication-permit/prohibit policies as values.

In the event of a search request with a UUID as a key, if a communication-permit/prohibit policy is stored in association with the UUID, policy database 122 returns this communication-permit/prohibit policy as the response, and if there is no communication-permit/prohibit policy stored in association with the UUID, policy database 122 returns the response “no communication-permit/prohibit policy.”

When there is a request to register a UUID and communication-permit/prohibit policy with the UUID as a key and the communication-permit/prohibit policy as values, policy database 122 stores the UUID and communication-permit/prohibit policy in association with each other.

Policy inquiry program 121m submits to user 40 an inquiry of the communication-permit/prohibit policy relating to the apparatus shown by the UUID.

Here, policy inquiry program 121m may indicate the UUID to user 40 and prompt the input of the communication-permit/prohibit policy, but user 40 may have difficulty determining which apparatus is actually indicated. As a result, policy inquiry program 121m may use the UPnP construct to acquire the device description of the apparatus and then indicate, for example, the name of the apparatus that is described in the device description to user 40 to prompt the input of the communication-permit/prohibit policy. Details regarding the device description are established in the UPnP standard.

Packet filtering rule combining program 121g produces packet filtering rules (communication selection rules) based on the communication-permit/prohibit policy and the IP address.

If an example of a packet filtering rule is here presented for a case in which the communication-permit/prohibit policy is “permit” for video recorder #2, the rule is “Of IP packets, pass IP packets for which one of the source IP address and destination IP address is ‘192.168.0.2’.”

If the communication-permit/prohibit policy is “prohibit,” the “pass” part in the above-described example becomes “block.” Old packet filtering rules deleting program 121l deletes the packet filtering rules that are related to UUID from packet filter 121h.

First, a request for a search using a UUID as a key is issued to packet filtering rules database 123. When the response “no packet filtering rules” is returned, the processing of old packet filtering rule deleting program 121i is ended.

If packet filtering rules are returned, a request is issued to packet filtering rule database 123 to delete these packet filtering rules, and further, these packet filtering rules (communication selection rules) are deleted from packet filter 121h.

Packet filtering rule database 123 stores UUID as keys and packet filtering rules as values in association with each other.

When there is a request for a search with a UUID as key, packet filtering rules are returned as the response if these packet filtering rules are stored in relation to the UUID, but if packet filtering rules are not stored in relation to the UUID, “no packet filtering rules” is returned as the response.

When there is a request to register packet filtering rules as values with a UUID as a key, the packet filtering rules and UUID are stored in association with each other.

When there is a request to delete with a UUID as a key, the UUID and packet filtering rules that are stored in association with each other are deleted.

Packet filtering rule setting program 121j sets packet filtering rules in packet filter 121h. Packet filter 121h filters packets that are transmitted/received by LAN interface 121a in accordance with the packet filtering rules (group) that have been set (This type of filtering structure is already known to those skilled in the art). Packet filter 121h can receive the settings of packet filtering rules.

In addition, regarding packet filtering rules that have been set, a deletion request can be received with the packet filtering rules as a key and the settings of the packet filtering rules that have been set can be released.

Packet filter 121h must further be set in advance to pass discovery searches, discovery responses, and advertisements. Packet filter 121h must further be set in advance to block packets that do not match any packet filtering rule (the default process is “block”).

Explanation next regards the operation of the above-described example.

Packet filter 121h is set in advance to pass discovery searches, discovery responses, and advertisements.

In addition, video recorder #2 multicasts advertisements in accordance with the UPnP standard. As a result, apparatus discovery program 121c can discover video recorder #2.

Upon discovering video recorder #2, an inquiry of the communication-permit/prohibit policy is submitted to user 40. It is here assumed that user 40 responds with “permit” as the communication-permit/prohibit policy for controlling video recorder #2. Packet filter 121h is set to permit communication with the current point of video recorder #2 at IP address (192.168.0.2).

Because all IP packets between PC 10 and video recorder #2 pass through packet filter 121h, SOAP requests pass from PC 10 to video recorder #2 and SOAP responses pass from video recorder #2 to PC 10, and user 40 can use recording application 121k to control video recorder #2.

It is here assumed that the power supply of video recorder #2 is once cut off and then reapplied. At this time, if it is assumed that the assignment of IP address of video recorder #2 is not fixed and that a mechanism such as DHCP is used to dynamically assign the IP address, the possibility arises that an IP address will be assigned to video recorder #2 that is different from the IP address before the power supply was cut off. It is here assumed that after the power supply is restored the IP address of video recorder #2 becomes “1192.168.0.6,” which differs from the IP address “192.168.0.2” before the power supply was cut off.

Apparatus discovery program 121c again discovers video recorder #2. At this time, UUID acquisition program 121d acquires a UUID that is equivalent to the UUID before the power supply was cut off (In the UPnP standard, the UUID of a UUID does not change even when the power is cut off). On the other hand, IP address acquisition program 121e acquires an IP address that differs from the IP address before the interruption of the power supply.

Because the UUID does not change, policy determination program 121f can acquire from policy database 122 the policy “permit” that was the response of user 40 before the power supply was cut off, and the communication-permit/prohibit policy can be determined without issuing an inquiry to user 40 after the power supply is restored.

Old packet filtering rules deleting program 121l discovers “Of IP packets, pass those IP packets for which either of the source IP address and destination IP address is ‘192.168.0.2’” that has been placed in relation to the UUID and deletes this packet filtering rule from packet filtering rule database 123 and packet filter 121h.

In this way a packet filtering rule can be deleted that relates to the IP address before the interruption of the power supply that was not already assigned to video recorder #2.

Packet filtering rule setting program 121j stores the rule “Of IP packets, pass those IP packets for which either of the source IP address and destination IP address is ‘192.168.0.6’” in packet filtering rule database 123 in association with the UUID. Packet filtering rule setting program 121j further sets this packet filtering rule in packet filter 121h.

This enables the setting of a packet filtering rule that relates to the IP address that is newly assigned to video recorder #2 after the restoration of the power supply and allows user 40 to control video recorder #2.

When recording application 121k has a bug or has been infected by a computer virus, the possibility exists that recording application 121k will attempt communication with invalid PC #3. Here, the transmission of input of user 40 to invalid PC #3 will result in an attempt of escape of personal information.

However, even should recording application 121k attempt to communicate with invalid PC #3, packet filter 121h will not permit communication with invalid PC #3. This is because an advertisement from invalid PC #3 has not been received, and packet filtering rules that would permit communication with invalid PC #3 are therefore not set in packet filter 121h.

In addition, even if invalid PC #3 transmits SOAP requests to recording application 121k to interfere with the normal operations of recording application 121k, packet filter 121h again does not permit communication.

A method such as implementing an electronic signature in advertisements may also be used to authenticate the transmission origin of advertisements.

In this case, even when invalid PC #3 transmits an advertisement in an attempt to alter the settings of packet filter 121h, carrying out appropriate authentication can void the advertisement from invalid PC #3.

As an example, a procedure is adopted in which information specifying the manufacturer of the apparatus is included in an electronic signature and judgment of whether to receive or discard an advertisement is realized depending on whether the manufacturer of the apparatus can be trusted (this electronic signature technology is known to those expert in the art.).

Alternatively, when it is determined that video recorder #2 can be trusted by authenticating an advertisement of video recorder #2 by means of the electronic signature, the packet filtering rule “permit” may be set in packet filter 121h without submitting an inquiry to user 40 for a communication-permit/prohibit policy.

In this case, packet filter 121h can be set appropriately without having user 40 enter a communication-permit/prohibit policy.

Thus, in the above-described example, the IP address is acquired at the time of apparatus discovery, whereby a communication selection rule to pass only communication with this apparatus can be produced and set in the firewall, thereby enabling appropriate settings for controlling the outside apparatus. In addition, the policy is stored in association with a UUID, and the firewall settings can follow this change even should the IP address change at the time of rediscovery of the apparatus.

The present invention is not limited to the above-described exemplary embodiments and is open to various modifications within the scope of the invention, and these modification are obviously included within the scope of the present invention.

### UTILITY IN THE INDUSTRY

The present invention can be applied to such uses as improving the security of portable telephones or PC that make up an apparatus-linking system.

What is claimed is:

1. A communication control device for, when communication is carried out with an outside apparatus by way of a communication network, determining and controlling whether communication with said outside apparatus is to be permitted or not, said communication control device comprising:
a communication parameter acquisition means for acquiring communication parameters specifying the transmission origin of said outside apparatus based on existence information of said outside apparatus that is received from said communication network;
an apparatus identifier acquisition means for acquiring an apparatus identifier from said outside apparatus, said apparatus identifier being an identifier for said outside apparatus;
a policy determination means for determining a communication policy for permitting or prohibiting communication with an outside apparatus specified by said apparatus identifier;
a communication selection rule combining means for combining communication selection rules based on said communication policy and said communication parameters; and
a communication pass control means for passing or blocking communication with said outside apparatus based on communication selection rules that have been combined by said communication selection rule combining means.

2. The communication control device according to claim 1, further comprising:
a communication selection rule storage means for storing said communication selection rules and said apparatus identifiers in association with each other with said apparatus identifiers as keys and said communication selection rules that have been combined as values;
an old communication selection rule deleting means for releasing from said communication pass control means settings of communication selection rules that have been extracted from said communication selection rule storage means with apparatus identifiers as keys; and
communication selection rule setting means for both causing storage of sets of said apparatus identifiers and said communication selection rules in said communication selection rule storage means and making settings in said communication pass control means.

3. The communication control device according to claim 1, wherein said policy determination means both determines a first communication policy based on specific designated information that is received from an user of said outside apparatus by way of said outside apparatus, and further, determines the same content as said first policy for second and succeeding communication policies.

4. A communication control device according to claim 2, further comprising:
a communication selection rule updating means for, when reconnecting with said outside apparatus, both updating said communication selection rules that are stored in said communication selection rule storage means to communication selection rules that are newly determined and setting updated communication selection rules in said communication pass control means;
wherein said communication selection rule updating means is provided together with said communication selection rule setting means.

5. A communication control device for, when performing communication with an outside apparatus by way of a communication network, controlling whether communication with said outside apparatus is to be permitted or not, said communication control device comprising:
a policy storage means for storing a policy indicating permission or blockage of communication with said outside apparatus for each of apparatus identifier that uniquely identifies said outside apparatus;
an apparatus discovery means for detecting said outside apparatus based on existence information that is received from said communication network and that indicates an existence of said outside apparatus;
a communication parameter acquisition means for acquiring from said existence information communication parameters that specify the transmission origin of said outside apparatus that has been discovered by said apparatus discovery means;
an apparatus identifier acquisition means for acquiring from said existence information said apparatus identifier that has been discovered by said apparatus discovery means;
a policy determination means for both reading from said policy storage means a policy for an apparatus identifier that has been acquired by said apparatus identifier acquisition means and determining said policy that has been read as the policy of said outside apparatus;
a communication selection rule combining means for, based on said policy that has been determined by said policy determination means, said apparatus identifier acquired by said apparatus identifier acquisition means, and said communication parameters that have been acquired by said communication parameter acquisition means, combining communication selection rules that indicate whether to pass or block communication for an outside apparatus to which said apparatus identifier is assigned; and
a communication pass control means for passing or blocking communication with said outside apparatus based on said communication selection rules that have been combined.

6. The communication control device according to claim 5, further comprising:
a policy inquiry means for functioning when said policy determination means is unable to determine a policy of said apparatus identifier because said policy for said apparatus identifier was not stored in said policy storage means and inquiring for the policy of said outside apparatus to which said apparatus identifier has been assigned;
wherein said policy determination means both determines that said policy for which said policy inquiry means has inquired is to be the policy of said outside apparatus and causes said policy that has been determined to be stored in said policy storage means.

7. The communication control device according to claim 5, further comprising:
a communication selection rule storage means for storing communication selection rules that have been combined by said communication selection rule combining means together with corresponding said apparatus identifier; and
a communication selection rule storage determination means for determining whether communication selection rules having the same apparatus identifier as new communication selection rules that have been combined by said communication selection rule combining means are already stored or not in said communication selection rule storage means;
wherein said communication selection rule storage determination means, upon determining that communication selection rules of an apparatus identifier that are the same as newly combined communication selection rules are already stored in said communication selection rule storage means, updates said communication selection rules that are stored to the communication selection rules that have been newly combined.

8. The communication control device according to claim 5, wherein an electronic signature is implemented in said existence information; said communication control device further comprising:
a transmission origin authentication means for authenticating the transmission origin of said outside apparatus based on a signature that is implemented in existence information received from said outside apparatus; and
a reliability determination means for determining whether the transmission origin of said outside apparatus that has been authenticated by said transmission origin authentication means can be trusted;
wherein when said reliability determination means determines that the transmission origin of said outside apparatus can be trusted, said policy determination means makes the policy of said outside apparatus “permit communication,” and when said reliability determination means determines that the transmission origin of said outside apparatus cannot be trusted, said policy determination means makes the policy of said outside apparatus “block communication.”

9. A communication control system for, when carrying out communication between a terminal device and an outside apparatus by way of a communication network, determining and controlling whether to permit said communication or not; wherein:
said outside apparatus includes an existence information transmission means for transmitting existence information that indicates an existence of said outside apparatus itself to said terminal device; and
said terminal device is provided with a communication control device according to claim 1 as a communication control means, and includes a communication means for executing communication by way of said communication network and a user interface means for receiving and supplying necessary information.

10. A communication control method for, when carrying out communication with an outside apparatus by way of a communication network, determining and controlling whether to permit communication with said outside apparatus or not; said method comprising:
an apparatus identifier/communication parameter acquisition step of acquiring, from said outside apparatus, an apparatus identifier that is the identifier for said outside apparatus and communication parameters that specify the transmission origin of said outside apparatus from existence information of said outside apparatus that is received from said communication network;
a policy determination step of determining a communication policy for permitting or prohibiting communication with said outside apparatus that is specified by said apparatus identifier;
a communication selection rule combining step of combining communication selection rules based on said communication policy and said communication parameters; and
a communication pass control step carried out in a communication pass control means that functions based on communication selection rules that have been combined and sets passage or blockage of communication with said outside apparatus.

11. The communication control method according to claim 10, further comprising before said communication pass control step:
a communication selection rule storage step of storing in a communication selection rule storage means said apparatus identifier and said communication selection rules in association with each other with said apparatus identifier as a key and said combined communication selection rules as values;
an old communication selection rule deletion step of releasing settings from said communication pass control means for communication selection rules acquired from said communication selection rule storage means with said apparatus identifier as key; and
a communication selection rule setting step of both storing sets of said apparatus identifier and said communication selection rules in said communication selection rule storage means and setting in said communication pass control means.

12. The communication control method according to claim 11, further comprising a communication selection rule updating step of, when said communication selection rules are newly combined due to reconnection with said outside apparatus and before execution of said communication pass control step, updating said communication selection rules stored in said communication selection rule storage means to communication selection rules that have been newly determined.

13. A communication control method for, when carrying out communication with an outside apparatus by way of a communication network, controlling whether or not to permit communication with said outside apparatus; said method comprising:
an outside apparatus detection step of detecting said outside apparatus based on existence information that is received from said communication network and that indicates existence of said outside apparatus;
an apparatus identifier/communication parameter acquisition step of acquiring from said existence information communication parameters that specify the transmission origin of said outside apparatus that has been detected and the corresponding apparatus identifier;
a policy determination step of reading from a policy storage means, in which policies are stored in advance for each apparatus identifier, a policy that indicates whether to permit or block communication with an outside apparatus to which said apparatus identifier that has been acquired is assigned and determining said policy as the policy of said outside apparatus;
a communication selection rule combining step of, based on said policy that has been determined, and said apparatus identifier and communication parameters that have been acquired, combining communication selection rules that indicate whether to pass or block communication for said outside apparatus to which said apparatus identifier is assigned; and
a communication pass control step of executing determination based on said communication selection rules that have been combined and passing or blocking communication with said outside apparatus.

14. The communication control method according to claim 13, further comprising before said policy determination step:
a policy inquiry step for, when the policy for an apparatus identifier that was acquired in said apparatus identifier/communication parameter acquisition step was not stored in a policy storage means that was provided in advance and the policy for said apparatus identifier therefore cannot be determined, inquiring to the outside for the policy of said outside apparatus to which said apparatus identifier is assigned; and
a policy re-storing step for both determining the policy that obtained by inquiry as the policy of said outside apparatus and again storing said policy in said policy storage means.

15. The communication control method according to claim 13, further comprising before said communication pass control step:
a communication selection rule storage determination step for determining whether communication selection rules having the same apparatus identifier as communication selection rules that were combined in said communication selection rule combining step are already stored in a communication selection rule storage means that was provided in advance; and
a communication selection rule updating step for, when it is determined that communication selection rules of said apparatus identifier that have been combined are already stored, updating said communication selection rules that are stored to newly combined communication selection rules.

16. The communication control method according to claim 13, wherein an electronic signature is implemented in said existence information, said communication control method further comprising:
a transmission origin authentication step for authenticating the transmission origin of said outside apparatus based on a signature implemented in existence information that is received from said outside apparatus;
a reliability determination step for determining whether the transmission origin of said outside apparatus that has been authenticated can be trusted or not; and
a communication permission determination step for making the policy of said outside apparatus “permit communication” when it is determined that the transmission origin of said outside apparatus can be trusted and making the policy of said outside apparatus “block communication” when it is determined that the transmission origin of said outside apparatus cannot be trusted.

17. A communication control program products for, when carrying out communication with an outside apparatus by way of a communication network, determining and controlling whether or not to permit communication with said outside apparatus; said program causing a computer to execute processes of:
an apparatus identifier/communication parameter acquisition step of acquiring, from said outside apparatus, an apparatus identifier that is the identifier for said outside apparatus and communication parameters that specify the transmission origin of said outside apparatus based on existence information of said outside apparatus that is received from said communication network;
a policy determination step of determining a communication policy for permitting or prohibiting communication with said outside apparatus that is specified by said apparatus identifier;
a communication selection rule combining step of combining communication selection rules based on said communication policy and said communication parameters; and
a communication pass control step carried out in a communication pass control means that functions based on communication selection rules that have been combined and that sets passage or blockage of communication with said outside apparatus.

18. The communication control program products according to claim 17, said program causing a computer to, before said communication pass control step, execute further processes of:
a communication selection rule storage step of storing in a communication selection rule storage means said apparatus identifier and said communication selection rules in association with each other with said apparatus identifier as a key and said combined communication selection rules as values;
an old communication selection rule deletion step of releasing settings from said communication pass control means for communication selection rules acquired from said communication selection rule storage means with said apparatus identifier as key; and
a communication selection rule setting step of both storing sets of said apparatus identifier and said communication selection rules in said communication selection rule storage means and setting in said communication pass control means.

19. The communication control program products according to claim 17, said program causing a computer to, in said policy determination step, execute a process of both determining a first communication policy based on specific designated information that is received as input by way of said outside apparatus from an user of said outside apparatus and determining the same content as said first communication policy for second and succeeding communication policies.

20. The communication control program products according to claim 18 for causing a computer to execute a process of a communication selection rule updating step of, when said communication selection rules are newly combined due to reconnection with said outside apparatus and before execution of said communication pass control step, updating said communication selection rules stored in said communication selection rule storage means to communication selection rules that have been newly determined.

21. A communication control program products for, when carrying out communication with an outside apparatus by way of a communication network, determining and controlling whether or not to permit communication with said outside apparatus; said program causing a computer to execute processes of:
an outside apparatus detection step of detecting said outside apparatus based on existence information that is received from said communication network and that indicates existence of said outside apparatus;
an apparatus identifier/communication parameter acquisition step of acquiring from said existence information communication parameters that specify the transmission origin of said outside apparatus that has been detected and the corresponding apparatus identifier;
a policy determination step of reading from a policy storage means, in which policies are stored in advance for each apparatus identifier, a policy that indicates whether to permit or block communication with an outside apparatus to which said apparatus identifier that has been acquired is assigned and determining said policy as the policy of said outside apparatus;
a communication selection rule combining step of, based on said policy that has been determined and said apparatus identifier and communication parameters that have been acquired, combining communication selection rules that indicate whether to pass or block communication for said outside apparatus to which said apparatus identifier is assigned; and
a communication pass control step of executing determination based on said communication selection rules that have been combined and passing or blocking communication with said outside apparatus.

22. The communication control program products according to claim 21, said program causing a computer to further execute, before said policy determination step, processes of:
a policy inquiry step for, when the policy for an apparatus identifier that was acquired in said apparatus identifier/communication parameter acquisition step was not stored in a policy storage means that was provided in advance and the policy for said apparatus identifier therefore cannot be determined, inquiring to the outside for the policy of said outside apparatus to which said apparatus identifier is assigned; and
a policy re-storing step for both determining the policy that was obtained by inquiry as the policy of said outside apparatus and again storing said policy in said policy storage means.

23. The communication control program products according to claim 21, said program causing a computer to further execute, before said communication pass control step, processes of:
a communication selection rule storage determination step for determining whether communication selection rules having the same apparatus identifier as communication selection rules that were combined in said communication selection rule combining step are already stored in a communication selection rule storage means that has been provided in advance; and
a communication selection rule updating step for, when it is determined that communication selection rules of said apparatus identifier that have been combined are already stored, updating said communication selection rules that are stored to newly combined communication selection rules.
